(19) United States
(12) Patent Application Publication
(10) Pub. No.: US 2009/0320953 A1
(43) Pub. Date: Dec. 31, 2009

(54) Interstitially Insulated Pipes and Connection Technologies

(75) Inventors: Leroy S. Fletcher, College Station, TX (US); Egidio E. Marotta, Bryan, TX (US); Charles A. Bollfrass, Spring, TX (US)

Correspondence Address: CONLEY ROSE, P.C.;David A. Rose, P. O. BOX 3267, HOUSTON, TX, 77253-3267, US

(73) Assignee: THE TEXAS A&M UNIVERSITY SYSTEM, College Station, TX (US)

(21) Appl. No.: 11/742,241

(22) Filed: Apr. 30, 2007

Related U.S. Application Data
(63) Continuation-in-part of application No. 11/339,644, filed on Jan. 25, 2006, now abandoned.
(60) Provisional application No. 60/646,765, filed on Jan. 25, 2005.
(60) Provisional application No. 60/746,110, filed on May 1, 2006.

(51) Int. Cl. F16L 9/14; F16L 9/18; B23P 17/00; F17D 1/00

(52) U.S. Cl. 138/148; 138/149; 138/153; 29/890.14; 137/1; 137/236.1; 137/798

(57) ABSTRACT

An interstitially insulated pipeline for flowing a hydrocarbon. In an embodiment, the pipeline comprises a first interstitially insulated pipe and a second interstitially insulated pipe. Each interstitially insulated pipe comprises an inner pipe, an outer pipe mounted coaxially around the inner pipe, an insulating interstice radially positioned between the inner pipe and the outer pipe, and a layer of screen mesh having a mesh size 10 or less disposed in the insulating interstice. In addition, the pipeline comprises a joint coupling the first interstitially insulated tubular and the second interstitially insulated tubular end-to-end. The joint includes a connection that couples the outer pipe of the first interstitially insulated pipe to the outer pipe of the second interstitially insulated pipe, and an annular seal member disposed between the inner pipe of the first interstitially insulated pipe and the inner pipe of the second interstitially insulated pipe.

### CROSS-REFERENCE TO RELATED APPLICATIONS

This application is a continuation in part of U.S. application Ser. No. 11/339,644, filed Jan. 25, 2006, and entitled “Interstitial Insulation,” which claims the benefit of U.S. Provisional Application No. 60/646,765, filed Jan. 25, 2005, and entitled “Interstitial Insulation,” each of which is hereby incorporated herein by reference in its entirety. In addition, this non-provisional application claims the benefit of U.S. Provisional Application No. 60/746,110, filed May 1, 2006, and entitled “Interstitially Insulated Tubulars and Connection Technologies for Interstitially Insulated Tubulars,” which is hereby incorporated by reference in its entirety.

### STATEMENT REGARDING FEDERALLY SPONSORED RESEARCH OR DEVELOPMENT

This invention was made with Government support under research contracts from the Marine Mineral Service (MMS) (MMS Project #509) under Contract No. 0104RU35515. The government may have certain rights in this invention.

### BACKGROUND OF THE INVENTION

1. Field of the Invention

The present invention relates generally to the field of interstitially insulated materials and tubulars, and more particularly relates to interstitially insulated subsea pipes for flowing a hydrocarbon fluid.

2. Background of the Invention

With the ever-increasing demand for energy, the search for energy rich hydrocarbons (e.g., crude oil, natural gas, natural gas liquids etc.) has increased. The search and exploration for such hydrocarbons has expanded to all corners of the globe, including many offshore locations. As drilling and production activities advance to greater subsea depths, the challenges and complexities associated with transporting the well products (e.g., produced hydrocarbons) become more challenging. For instance, crude oil from the earth is generally produced at a relative warm temperature, typically in the range of 70° to 80° C. (˜160° to 175° F.). However, in some cases, produced hydrocarbons may initially have temperatures as high as 260° C. (˜500° F.). In contrast, the sea water immediately surrounding the production pipes near the sea floor can have a relatively cold temperature, typically about 0° C. to 5° C. (˜32° F. to 40° F.), particularly in some deepwater applications. Without sufficient insulation of the produced crude oil, the temperature of the produced crude oil may undesirably dip below the paraffin could point for crude oil, typically around 68° C. (˜155° F.). Below the paraffin cloud point, paraffin wax in the crude oil may begin to crystallize into solid particles and deposit on the inside surface of the production pipes and subsea pipeline. The buildup of paraffins on the inside of the production pipes and/or subsea pipeline may ultimately lead to narrowing and blockage of the pipeline. As a result, the production and flow of the crude through the subsea pipeline is reduced.

One conventional approach to deal with paraffin build-up in a subsea pipeline is to employ a pig or other device that is positioned in the pipeline and advanced through the pipeline to break up and flush out the paraffin on the inner pipe surface. However, the use of pigs is a reactive method to deal with paraffin wax buildup, and further, the use of pigs takes time, money, and must be periodically repeated to address paraffin wax build-up.

Another conventional approach to address undesirable paraffin wax buildup is to employ a coating on the inside surface of the subsea pipeline to limit adhesion of paraffin wax on the inner pipe surface and/or to insulate the crude oil flowing through the subsea pipeline. However, such coatings may wear off or degrade over time, especially when there is physical contact and relative motion between the coating and the fluid (e.g., crude oil) flowing through the pipeline. For instance, the produced crude oil may contain sand or other abrasive elements that wear away the coating over time. As another example, the corrosive nature of produced crude oil may break down the coating over time. The wearing away and/or degradation of such a coating tends to reduce its insulating effectiveness, potentially leading to paraffin wax buildup issues.

Still yet another conventional approach to address undesirable paraffin wax buildup involves the use of one or more layers of insulation provided on the outside of the subsea pipeline to insulate the crude oil flowing therein. However, it may not be practical or economically feasible to obtain the desired insulating capabilities (e.g., thermal resistance, thermal performance, etc.) with such techniques. Further, multiple layers of insulating material(s) may complicate the handling, manipulation, and installation of such insulating materials. For example, conventional layers of foam insulation provided on the outside of a pipe may crack or become damaged under bending or impact loads experienced during transport, handling, and/or installation. Damage to the insulating material may reduce its effectiveness and useful life. As another example, in cases where the desired thermal performance dictates relatively thick layers of insulation (e.g., thick layers of foam insulation necessary to insulate deepwater oil pipelines), the shear size and thickness of such pipes can present transportation and handling challenges. Still further, some multi-layered insulating materials may present manufacturing complexities.

Consequently, there is a need for improved devices and methods for insulting pipelines. Such devices and methods would be particularly well received if they could be advantageously employed to sufficiently insulate deepwater oil/gas production pipelines while reducing the costs and size as compared to conventionally insulated subsea pipelines. Further, needs include improved insulating materials and methods that are easier to manufacture, handle, manipulate, and install.

### BRIEF SUMMARY OF SOME OF THE PREFERRED EMBODIMENTS

In accordance with at least one embodiment described herein, an interstitially insulated pipeline for flowing a hydrocarbon comprises a first interstitially insulated pipe and a second interstitially insulated pipe. Each interstitially insulated pipe comprises an inner pipe, an outer pipe mounted coaxially around the inner pipe, an insulating interstice radially positioned between the inner pipe and the outer pipe, and a layer of screen mesh having a mesh size of 10 or less disposed in the insulating interstice and at least partially engaging the inner pipe and the outer pipe. In addition, the interstitially insulated pipeline comprises a joint coupling the first interstitially insulated tubular and the second interstitially insulated tubular end-to-end. The joint includes a connection that couples the outer pipe of the first interstitially insulated pipe to the outer pipe of the second interstitially insulated pipe, and an annular seal member disposed between the inner pipe of the first interstitially insulated pipe and the inner pipe of the second interstitially insulated pipe.

In accordance with other embodiments described herein, a method of fabricating a subsea pipeline comprises providing a first and a second interstitially insulated pipe segment. Each interstitially insulated pipe segment comprising an inner pipe, an outer pipe coaxially mounted about the inner pipe, an insulating interstice positioned between the inner pipe and the outer pipe, and a plurality of layers of screen mesh disposed in the insulating interstice. Further, each layer of screen mesh has a mesh number between 10 and 2. In addition, the method comprises connecting the first interstitially insulated pipe segment to the second interstitially insulated pipe segment end-to-end. Still further, the method comprises forming a joint between the first interstitially insulated pipe segment and the second interstitially insulated pipe segment. Moreover, the method comprises disposing the first interstitially insulated pipe segment at least partially subsea.

In accordance with other embodiments described herein, a method for transporting a hydrocarbon fluid comprises disposing a first tubular at least partially subsea. In addition, the method comprises flowing the hydrocarbon fluid through the first tubular. Further, the method comprises insulating the hydrocarbon fluid flowing through the first tubular with an interstice between the first tubular and a second tubular coaxially disposed about the first tubular. Still further, the method comprises maintaining the interstice between the first tubular and a second tubular with a layer of screen mesh disposed between the first tubular and the second tubular.

In accordance with other embodiments described herein, a subsea pipeline comprises a rigid inner pipe. In addition, the subsea pipeline comprises a rigid outer pipe disposed coaxially around the inner pipe so as to form an interstice between the inner pipe and the outer pipe. Further, the subsea pipeline comprises a layer of screen mesh disposed in the interstice between the inner tubular and the outer tubular, wherein the screen mesh has a mesh number of 10 or less.

Thus, embodiments described herein comprise a combination of features and advantages intended to address various shortcomings associated with certain prior devices. The various characteristics described above, as well as other features, will be readily apparent to those skilled in the art upon reading the following detailed description of the preferred embodiments, and by referring to the accompanying drawings.

### BRIEF DESCRIPTION OF THE DRAWINGS

For a detailed description of the preferred embodiments of the invention, reference will now be made to the accompanying drawings in which:

FIG. 1 is a partial cut-away perspective view of an embodiment of an interstitially insulated pipe;

FIG. 2 is an enlarged partial cross-section view of the interstitially insulated pipe shown in FIG. 1;

FIG. 3 is a front view of a variety of geometries for the screen mesh separator of the interstitially insulated pipe shown in FIGS. 2 and 3;

FIG. 4 is a partial cut-away perspective view of an embodiment of an interstitially insulated pipe;

FIG. 5 is an enlarged partial cross-section view of the interstitially insulated pipe shown in FIG. 4;

FIG. 6 is a partial cut-away perspective view of an embodiment of an interstitially insulated pipe;

FIG. 7 is a partial cross-sectional view of an embodiment of a pipeline formed from the interstitially insulated pipes shown in FIG. 1;

FIG. 8 is an enlarged partial cross-sectional view of an embodiment of the seal assembly shown in FIG. 7;

FIG. 9 is an enlarged partial cross-sectional view of an embodiment of the seal assembly shown in FIG. 8;

FIG. 10 is a partial cross-sectional view of an embodiment of a pipeline formed from the interstitially insulated pipes shown in Figure;

FIG. 11 is a schematic front view of a test specimen utilized in the experiment described in EXAMPLE 1;

FIG. 12 is a front view of the Thermal Contact Conductance (TCC) system utilized to conduct the experiments described in EXAMPLES 1, 2, and 3;

FIG. 13 graphically illustrates the results for the stainless steel screen mesh specimens tested in EXAMPLE 1;

FIG. 14 graphically illustrates the results for the titanium screen mesh specimens and stainless steel 5 screen mesh specimens tested in EXAMPLE 1;

FIG. 15 graphically illustrates the results for the tungsten screen mesh specimens and the stainless steel 5 screen mesh specimens tested in EXAMPLE 1;

FIG. 16 graphically illustrates the results for the stainless steel 5 screen mesh specimens tested in EXAMPLE 2 compared to existing pipe technology;

FIG. 17 illustrates a front view of a test specimen utilized in the experiment described in EXAMPLE 3; and

FIG. 18 graphically illustrates the results for the inconel screen mesh specimens tested in EXAMPLE 3.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

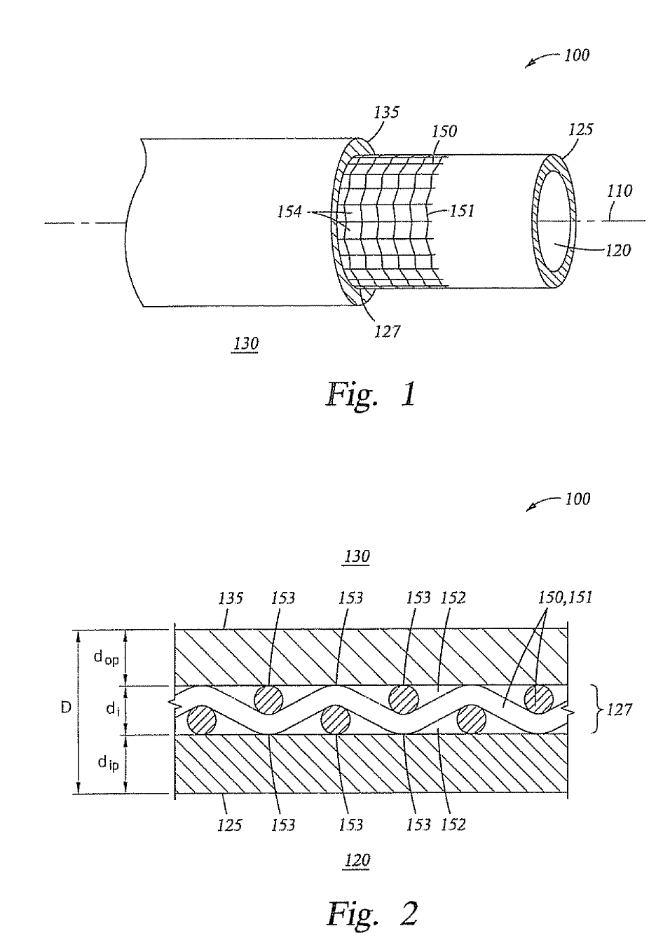

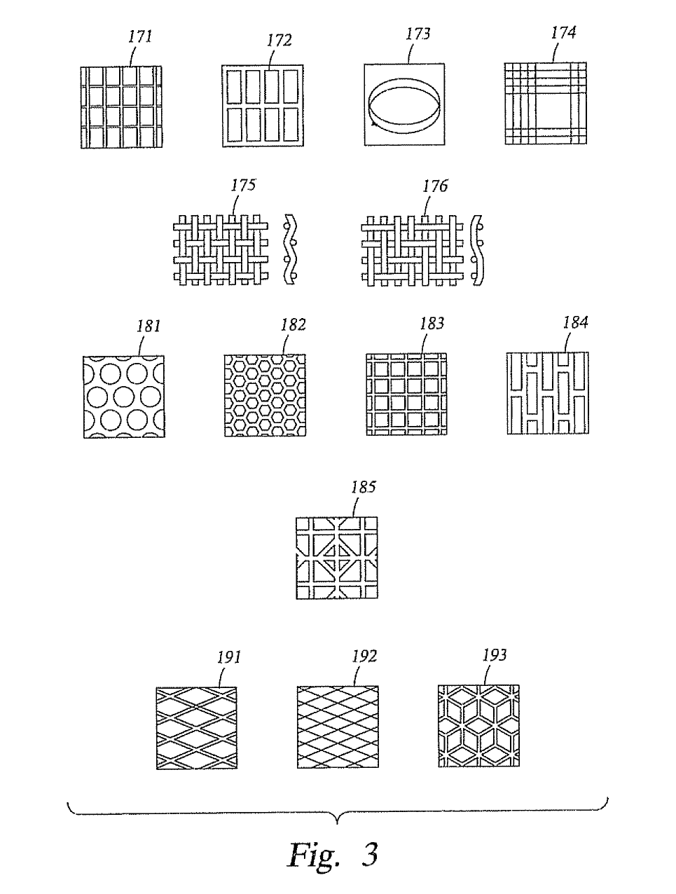

An interstitially insulated tubular or pipe 100 is shown in FIGS. 1 and 2 and is believed to have particular utility when employed in a subsea pipeline to flow one or more produced hydrocarbons or well products (e.g., crude oil, natural gas, liquid natural gas, etc.). However, interstitially insulated tubular 200 may also be employed in a variety of other applications such as a riser that flows hydrocarbons to the surface, a pipeline in a petrochemical plant to flow one or more fluids, in a nuclear power plant to flow steam, etc. It is to be understood that the embodiment of interstitially insulated pipe 100 shown in FIGS. 2 and 3 represents a single segment of interstitially insulated pipe 100, however, as will be explained in more detail below, multiple segments of interstitially insulated pipe 100 may be coupled end-to-end to form a pipeline of any desired length.

Referring now to FIGS. 1 and 2, interstitially insulated pipe or tubular 100 comprises an inner tubular or pipe 125 defining an inner flow passage or region 120, an outer tubular or pipe 135 disposed about inner pipe 125, an insulating interstice 127 disposed between inner pipe 125 and outer pipe 135, and a separator 150 disposed in interstice 127. Inner pipe 125 and outer pipe 135 are substantially coaxially aligned, sharing the same central axis 110. Separator 150, inner pipe 125, and outer pipe 135 may be held together by any suitable means, including without limitation spot welding, press fitting, adhesive, vacuum, static pressure, or combinations thereof.

Inner pipe 125 and outer pipe 135 each generally comprise an elongate tubular or pipe. Inner pipe 125 is preferably adapted to flow a fluid (e.g., well products) through region 120. Each pipe 125, 135 has a radial thickness dᵢₚ, dₒₚ, respectively. The inner diameter of outer pipe 135 is greater than the outer diameter of inner pipe 125 such that outer pipe 135 may be coaxially disposed around inner pipe 125. More specifically, the inner diameter of the outer pipe 135 is sufficiently greater than the outer diameter of the inner pipe 125 such that interstice 127 having a radial thickness dᵢ is formed therebetween. It should be appreciated that the radial thickness of separator 150 is equal to or less than radial thickness dᵢ. Consequently, the sum of radial thicknesses dᵢₚ, dₒₚ, and dᵢ define the overall radial thickness D of interstitially insulated tubular 100.

It should be appreciated that the greater the radial thickness dᵢ of interstice 127, the greater its thermal resistance and the better its insulating ability. However, on the other hand, as radial thickness dᵢ of interstice 127 increases, so does the diameter of outer pipe 135 and overall diameter of interstitially insulated pipe 100. In general, larger diameter pipes (e.g., outer pipe 135) are more expensive, and further, the larger the overall outside diameter of interstitially insulated pipe 100, the greater the bulk, transport and handling challenges.

In the embodiment shown in FIGS. 1 and 2, the inner and outer surfaces of tubulars 125, 135 are generally smooth. However, in other embodiments, the inner, outer, or both surfaces of inner tubular 125, outer tubular 135, or any combination thereof may be textured. Any suitable texturing may be employed including, without limitation, knurled, sand blasting, surface striations (e.g., scratching), or combinations thereof. Without being limited by this or any particular theory, smooth or polished surfaces generally reduce radiative heat transfer by reflecting heat, while irregular contact surfaces (e.g., rough, knurled, etc.) reduce conductive heat transfer by reducing the contact surface area available for conduction.

Referring still to FIGS. 1 and 2, separator 150 is disposed in interstice 127 between pipes 125, 135, and maintains the separation distance dᵢ between inner pipe 125 and outer pipe 135. The contact surface area between separator 150 and each pipe 125, 135 is preferably minimized to reduce conductive heat transfer. However, some degree of contact between separator 150 and each pipe 125, 135 is preferred to maintain the separation of pipes 125, 135. To enhance the insulating capabilities of interstitially insulated pipe 100, separator 150 preferably comprises a lower thermal resistance material. In general, the radial thickness of separator 150 defines the minimum radial thickness dᵢ of insulating interstice 127.

In this embodiment, separator 150 comprises a screen mesh 151 including a plurality of holes 154. Screen mesh 151 maintains the separation of pipes 125, 135 while providing a limited number of contact points 153 between screen mesh 151 and pipes 125, 135. Further, each contact point 153 defines a relatively small contact surface area with pipe 125, 135. As a result of the geometry of screen mesh 151, a plurality of gaps 152 are formed adjacent contact points 153 between screen mesh 151 and each respective tubular 125, 135. It is to be understood that holes 54 refer to the spaces or voids provided in separator 150, while gaps 152 refer to the spaces or voids within insulating interstice 127. Gaps 152 and holes 154 preferably comprise an insulating medium or material including, without limitation, a vacuum, a gas (e.g., air or argon gas), foam insulation, phase change material(s), hollow glass spheres, a powder (e.g., titanium dioxide power), or combinations thereof. For instance, in some embodiments, interstice 127 includes screen mesh 151 as well as a plurality of hollow glass nanospheres having a diameter between 50 and 100 microns. Such hollow nanospheres may optionally be coated with a heat reflective material such as aluminum.

Although a single screen mesh 151 is shown in FIGS. 2 and 3, in other embodiments, multiple layers of screen mesh (e.g., screen mesh 151) may be included between the inner pipe (e.g., inner pipe 125) and the outer pipe (e.g., outer pipe 135) to achieve and maintain the desired degree of separation (e.g., separation distance dᵢ) between the inner pipe and the outer pipe. In such embodiments including multiple layers of screen mesh, an intermediate or shim layer of material may be provided between adjacent layers of screen mesh.

The number of contact points and the size of gaps 152 and holes 154 is at least partially dependent on the mesh size or number of screen mesh 151. As is known in the art, mesh size or number generally refers to the number of strands of mesh material per linear inch of mesh material. In general, the lower the mesh number or size, the fewer the contact points between screen mesh 151 and each pipe 125, 135. However, at least some contact points are desirable in order for screen mesh 151 to affirmatively maintain some degree of separation between pipes 125, 135. It should be appreciated that since the mesh number or size is based upon the number of strands or threads of mesh material per linear inch of screen mesh, the thickness of the mesh may depend, at least in part, on the mesh number or size.

By maintaining the separation of tubulars 125, 135 (i.e., maintaining insulting interstice 127 between pipes 125, 135), limiting the number of conductive pathways between tubulars 125, 135 to contact points 153, and limiting the size and contact surface area of each contact point 153, screen mesh 151 offers the potential to reduce conductive heat transfer between regions 120, 130. By at least partially restricting fluid movement within interstice 127 to relatively confined gaps 152 and holes 154, screen mesh 151 also offers the potential to reduce convective heat transfer between regions 120, 130. Consequently, interstitially insulated tubular 100 insulates inner region 120 that flows a fluid (e.g., well products, produced hydrocarbons, etc.) from outer region 130, thereby resisting the flow of thermal energy when a temperature differential or gradient exists therebetween.

Referring still to the embodiment shown in FIGS. 1 and 2, although separator 150 is shown as a screen mesh with generally square holes 154, in general, any suitable mesh geometry or configuration may be employed. Examples of suitable geometries for a screen mesh include, without limitation, weave geometries, non-weave geometries (e.g., perforated materials, expanded materials, helix coiled wires, etc.), or combinations thereof. FIG. 3 illustrates a non-exclusive sampling of mesh geometries that may be employed for separator 150. For instance, separator 150 may comprise a square mesh 171, a rectangular mesh 172, a sieved mesh 173, an architectural mesh 174, etc. Further, separator 150 may comprise a plain weave 175, a twill weave 176, etc. As an alternative to a weave configuration, separator 150 may comprise a non-weave geometry, including without limitation a perforated material (e.g., round perforations 181, hexagonal perforations 182, square perforations 183, slotted perforations 184, decorative perforations 85, etc.), an expanded material (e.g., flattened expansions 191, standard expansions 192, decorative expansions 193, etc.), or combinations thereof. Likewise, the holes in the screen mesh (e.g., holes 154 in separator 150) may comprise any suitable shape including without limitation rectangular, elliptical, hexagonal, helix coils, etc. The mesh wire diameter and the mesh size (i.e., the number of strands per inch of the mesh material) may vary depending on a variety of factors such as the application, the conditions experienced (e.g., loads, pressures, etc.), the desired material properties, etc.

As previously described, the subsea environment through which some subsea pipelines traverse can be harsh. For instance, in some deepwater pipeline applications, water temperatures can approach freezing (e.g., between 0° C. and 5° C. (˜32° F. to 40° F.)), pressures can exceed 52,000 kPa (˜7,500 lbs/in²), the pipeline is surrounded by corrosive salt water, and the inside of the pipeline flows potentially corrosive hydrocarbons. In such environments, the strength, durability, and integrity of the pipeline is important. Thus, in an embodiment of interstitially insulated pipe 100 particularly suited of subsea pipeline applications, inner pipe 125 and/or outer pipe 135 comprise(s) a rigid steel pipe, and more preferably comprise(s) a low carbon or medium carbon steel pipe having a radial thickness dᵢₚ, dₒₚ, respectively, between 0.125 in. and 1.500 in. (˜0.318 cm to 3.81 cm), and more preferably about 1.00 in. (˜2.54 cm).

In general, one or both pipes 125, 135 may be used to provide sufficient structural support and strength for interstitially insulated pipe 100 under subsea conditions. For instance, if inner pipe 125 is employed as the primary structural support member, then inner pipe 125 preferably comprises a steel pipe having a radial thickness dᵢₚ between 0.125 in. and 1.500 in. (˜0.318 cm to 3.81 cm), and more preferably about 1.00 in. (˜2.54 cm), while outer pipe 135 may comprise a relatively thin sheath or pipe that relies on the underlying inner pipe 125 for structural support in the subsea environment. As another example, if outer pipe 135 is employed as the primary structural support member, then outer pipe 135 preferably comprises a steel pipe having a radial thickness dₒₚ between 0.125 in. and 1.500 in. (˜0.318 cm to 3.81 cm), and more preferably about 1.00 in. (˜2.54 cm), while inner pipe 125 may comprise a relatively thin sheath or pipe that relies on outer pipe 135 for structural support. Alternatively, in other embodiments, both inner pipe 125 and outer pipe 135 may comprise steel pipes having radial thicknesses dᵢₚ, dₒₚ between 0.125 in. and 1.500 in. (˜0.318 cm to 3.81 cm).

As described above, without being limited by this or any particular theory, the greater the radial thickness dᵢ of insulating interstice 127, the greater the insulating capability of interstitially insulating pipe 100. However, a larger radial thickness dᵢ may necessitate a larger size outer pipe 135, which tend to be more expensive, and difficult to handle (e.g., transport, install, etc.). Thus, to balance these competing factors in subsea applications, radial thickness dᵢ of insulating interstice 127 is preferably at least 0.0625 in. (˜0.159 cm), and more preferably between 0.125 in. to 1.00 in (˜0.318 cm to 2.54 cm). As will be described in more detail, in some embodiments, more than one insulating interstice may be provided between the inner pipe (e.g., inner pipe 125) and the outer pipe (e.g., outer pipe 135). In such cases, the sum of the radial thickness of each insulating interstice is preferably at least 0.0625 in. (˜0.159 cm), and more preferably between 0.125 in. to 1.00 in (˜0.318 cm to 2.54 cm).

In addition, since the outer radial surface of outer pipe 135 will be exposed to salt water (i.e., salt water in outer region 130), and the inner radial surface of inner pipe 125 will be exposed to the potentially corrosive hydrocarbon fluids flowing through region 120 (e.g., crude oil), it is preferred that the outer surface of outer pipe 135 comprise or be coated with a salt water resistance material (e.g., polypropylene coating) and the inner surface of inner pipe 125 may comprise or be coated with an corrosive resistant material (e.g., corrosive resistant metallic liner, polypropylene, etc.). The inner surface of inner pipe 125 preferably comprises an acid resistant material (e.g., stainless steel, inconel, chrome, etc.) since sulfur contained in crude oil may combine with hydrogen to produce sulfuric acid (H₂SO₄), hydrogen sulfide (H₂S), or combinations thereof. For instance, in some embodiments, inner pipe 125 may comprise a composite pipe made from a steel pipe having a stainless steel or inconel liner (e.g., a 0.0625 in. thick liner). Although solid steel pipes 125, 135 provide some durability under such corrosive conditions, additional protection and longevity may be achieved with the addition of more corrosive resistant coatings and/or surfaces.

For subsea applications, screen mesh 151 preferably comprises a durable metal or metal alloy screen mesh having a relatively high thermal resistance (i.e., a relatively low thermal conductivity), including without limitation stainless steel, titanium, neodymium, inconel alloys, tungsten, etc. Due to its relatively low cost, general availability, and corrosion resistant properties, stainless steel is most preferred. Such metal or metal alloy screen mesh for use subsea preferably has a mesh size or number less than 10, and more preferably 5 or less. In some embodiments, the metal or metal alloy screen mesh has a mesh size or number as low as 2.

In general, the radial thickness of screen mesh 151 defines the minimum radial thickness dᵢ of insulating interstice 127. As previously described, in subsea applications, radial thickness dᵢ of insulating interstice 127 is preferably at least 0.0625 in., and more preferably between 0.125 in. and 1.00 in. (˜0.318 cm to 2.54 cm). Consequently, the radial thickness of screen mesh 151 is preferably at least 0.0625 in., and preferably between 0.125 in. and 1.00 in. (˜0.318 cm to 2.54 cm). As previously described, thickness of an individual layer of screen mesh (e.g., screen mesh 151) will depend, at least in part, on the mesh size or number. Thus, although a single screen mesh 151 is shown in FIGS. 1 and 2, multiple layers of screen mesh (e.g., screen mesh 151) may be necessary to achieve the desired minimum radial thickness dᵢ of the insulating interstice (e.g., insulating interstice 127). For example, in some embodiments, ten layers or more of screen mesh may be required to achieve the preferred radial thickness dᵢ for the insulating interstice (e.g., insulating interstice 127).

The holes 54 and gaps 52 in screen mesh 151 are preferably filled with air, a vacuum, or argon. In other words, the remaining volume within insulating interstice 127 is preferably filled with air, a vacuum, or argon. Taking into account costs, simplicity, and availability, air is the more preferred medium. Moreover, depending on contents of gaps 152 and holes 154, separator 150 may also comprise a corrosive resistance outer surface or coating. To reduce heat transfer between regions 120, 130 in a subsea environment, sea water is preferably restricted from entering holes 54 and gaps 52. In other words, the insulating interstice between the inner and outer pipe (e.g., insulating interstice 127) is preferably not in fluid communication with the surrounding sea water.

These preferred materials and geometries for screen mesh 151 for use in subsea applications offer the potential for (1) a relatively high thermal resistance (i.e., a relatively low thermal conductivity), (2) a limited number of relatively small contact points (in general, the smaller the mesh number the fewer contact points per inc), (3) sufficient structural strength and integrity to restrict pipes 125, 135 from contacting each other (particularly when pipes 125, 135 comprise relatively heavy steel pipes) and when the interstitially insulated pipe 100 is moderately bent or sustains an impact load during handling, installation, or use.

The thermal resistance and insulating capability of embodiments of interstitially insulated pipe 100 (i.e., between inner region 120 and 130 radially across the pipe wall) may be described in terms of an overall heat transfer coefficient (hⱼ) expressed in W/m²K. In general, the lower the overall heat transfer coefficient (hⱼ), the better the insulating capability (i.e., less heat transfer). Embodiments of interstitially insulated pipe 100 designed in accordance with the principles described herein offer the potential for a subsea pipe or pipeline having an overall heat transfer coefficient less than 300 W/m²K. More specifically, some embodiments of interstitially insulated pipe 100 offer the potential for a subsea pipe or pipeline having an overall heat transfer coefficient (hⱼ) less than 50 W/m²K, or even lower than 10 W/m²K.

In the manner described, embodiments of interstitially insulated pipe 100 particularly designed and configured for subsea use offer the potential for a subsea pipeline sufficiently insulated to reduce and/or prevent the formation and buildup of paraffin wax within the subsea pipeline. In other words, embodiments of interstitially insulated pipe 100 designed for subsea use offer the potential to transport and sufficiently insulate produced crude oil having a production temperature between 70° to 76° C. (160° to 170° F.) through sea water commonly in the range of about 0° C. to 5° C. (˜32° F. to 40° F.) without the temperature of the crude oil dipping below the paraffin cloud point. Consequently, embodiments of interstitially insulated pipe 100 reduce and/or eliminate the need for some of the conventional approaches to address paraffin wax buildup (e.g., chemical additives, coatings, pigging, layers of foam insulation, etc.). By eliminating the need for additional outer layers of foam insulation that can be easily damaged by impact loads or bending, embodiments of interstitially insulated pipe 100 offer the potential for a subsea pipe that is more robust, durable, and less susceptible to damage, even under moderate impact forces and bending.

Still further, some conventional subsea pipelines have a relatively large radial wall thickness of about 3.5 in. to 10 in. (˜8.89 cm to 25.4 cm), resulting from the choice of pipe and various layers of insulation wrapped around the outside of the pipeline. However, for a similar inner diameter and similar flow capabilities, embodiments of interstitially insulated pipe 100 offer the potential for a subsea pipeline with a relatively thinner radial wall thickness between (e.g., between 0.50 in. and 4.0 in.), and resulting reduced bulk and greater flexibility. Consequently, as compared to some convention foam insulated subsea pipes, the improved flexibility and the reduced bulk (i.e., reduced outer diameter) of embodiments of interstitially insulated pipe 100 may simplify the transport, handling, installation, and movement of the pipeline.

Although embodiments of interstitially insulated pipe 100 are described above in reference to subsea hydrocarbon pipeline applications, in general, interstitially insulated pipe 100 may be employed in a variety of alternative applications to insulate a fluid flowing within region 120 from outer region 130. For instance, interstitially insulated pipe 100 may be employed in a petrochemical plant to insulate and flow chemical products or employed in a nuclear reactor facility to flow cooling water for the reactor core. Likewise, although preferred materials and dimensions for an embodiment of interstitially insulated tubular 100 particularly suited for subsea pipeline use are discussed in detail above, it should be appreciated that the materials and dimensions of interstitially insulated tubular 100 may be customized or tailored for a variety of potential applications. The particular application (e.g., in a petrochemical plant, nuclear power facility, etc.) and the expected loads (e.g., impact forces, pressures, etc.) will likely impact the selection of materials for each pipe 125, 135, separator 150, and the contents of any gaps 152 and holes 154 formed in insulating interstice 127. For example, if the contact pressure exerted on separator 150 by pipes 125, 135 is relatively high, and deformation of separator 150 is undesirable, then separator 150 preferably comprise a mechanically rigid material (e.g., stainless steel). However, if some deformation of separator 150 is acceptable, then separator 150 may comprise a less mechanically rigid material (e.g., foam, rubber, etc.). In addition, depending on the fluid flowed in passage 120, the environment of region 130, and the contents of any gaps 152 and holes 154, corrosive resistance material (e.g., stainless steel, zinc, etc.) and/or protective coatings (e.g., plastic, protective paint, etc.) may be considered.

For instance, embodiments of interstitially insulated pipe 100 may be employed in a conventional power plant or nuclear power plant to reduce the heat loss from steam lines. In such applications, the interstitially insulated pipe is preferably constructed of materials that do not absorb water vapor or moisture. As compared to conventionally insulated pipes, embodiments of interstitially insulated pipe 100 offer the potential for greater durability and lifetime. Likewise, embodiments of interstitially insulated 100 may be formed into other shapes suitable for other applications such as for reactor fuel storage or shipping casks, or for long term storage of spent fuel. In such applications involving neutron sources or neutron emitting fuels, a sheet or layer of lead is preferably included in the insulating interstice to capture spurious radiation.

In the embodiment shown in FIGS. 1 and 2, one separator 150 (e.g., screen mesh 151) and one insulating interstice 127 is provided between pipes 125, 135. However, in other embodiments, one or more additional separators (e.g., separator 150), insulating interstices (e.g., interstice 127), material layers, or combinations thereof may be included between pipes 125, 135. Such additional layers, separators, and/or interstices may be provided a variety of reasons including, without limitation, for structural purposes, to improve the thermal resistance, etc.

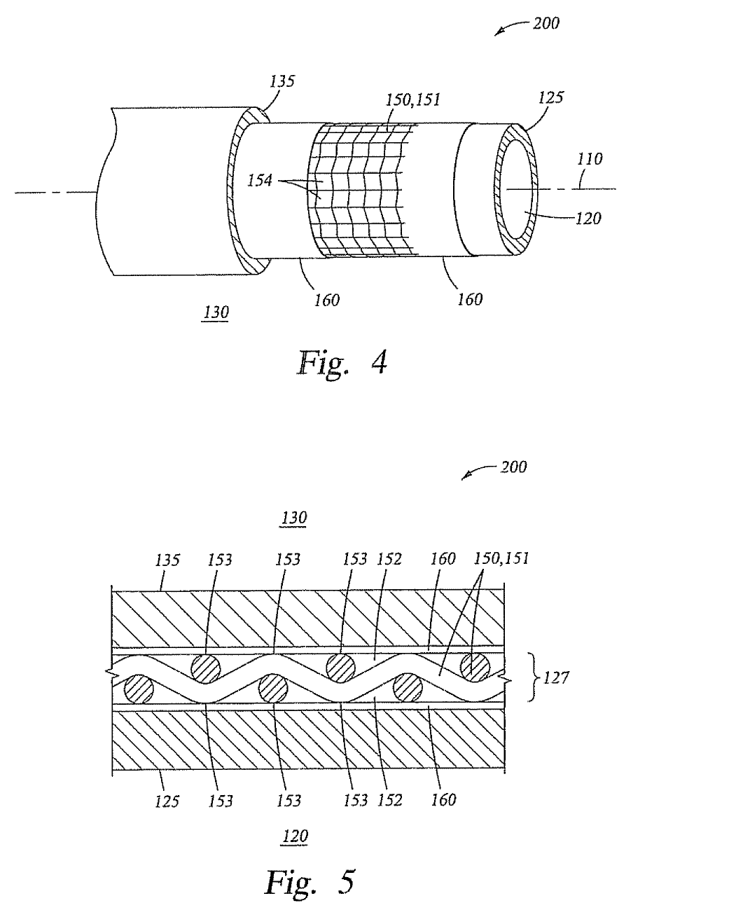

Referring now to FIGS. 4 and 5, another embodiment of an interstitially insulated tubular or pipe 200 believed to have particular utility when employed in a subsea pipeline to flow one or more produced hydrocarbons is shown. Interstitially insulated tubular 200 is substantially the same as interstitially insulated pipe 100 previously described with the exception that interstitially insulated pipe 200 includes additional layers 160 disposed between inner and outer pipes 125, 135, respectively. More specifically, one layer 160 is disposed between separator 150 and inner tubular 125 and a second layer 160 is disposed between separator 150 and outer tubular 135.

Each layer 160 may comprise any suitable material including without limitation a polymer (e.g., MYLAR®), a coated polymer (e.g., aluminized MYLAR®), a heat reflective material (e.g., a thin layer of aluminum), ceramic felt, etc. The selection of material for one or both layers 160 may depend on the application and the mode of heat transfer to be restricted (e.g., conduction, convection, radiation). For instance, a heat reflective layer (e.g., thin layer of aluminum) may be included within interstitial insulation 100 to limit radiative heat transfer between pipes 125, 135.

Referring now to FIG. 6, another embodiment of an interstitially insulated tubular or pipe 300 is illustrated. Pipe 300 is substantially the same as interstitially insulated tubular 100 previously described, except that pipe 300 includes an intermediate layer 131, an additional interstice 127, and an additional separator 150. In particular, one separator 150 is disposed around inner pipe 125 in an interstice 127 formed between inner pipe 125 and intermediate layer 131, and the other separator 150 is disposed around intermediate layer 131 in a second interstice formed between intermediate layer 131 and outer pipe 135. Additional interstices 127, intermediate layers 131, and separators 150 may be provided as desired. In this embodiment, each separator 150 is a screen mesh 151 as previously described.

Referring still to FIG. 6, in general, intermediate layer 131 may comprise a pipe, or simply comprise a continuous sheet of material such as MYLAR®. However, intermediate layer 131 preferably comprises a material that maintains separation of screen meshes 151 and minimizes the contact surface area between each screen mesh 151 and intermediate layer 131. For instance, intermediate layer 131 restricts screen meshes 151 from intermeshing. In other words, intermediate layer 131 restricts the ability of the radially inner and outer contact points of one screen mesh from orienting themselves within the holes and gaps of an adjacent screen mesh. Without being limited by theory, such consequences may detrimentally increase the thermal conductivity of interstitially insulated tubular 300. Thus, in embodiments including multiple layers of screen mesh, an intermediate layer (e.g., intermediate layer 131) or shim layer is preferably disposed between each pair of adjacent screen meshes.

A variety of suitable methods for manufacturing interstitially insulated pipe 100, 200, 300 may be employed, including without limitation shrink-fit techniques, hydrostatic pressure techniques, or combinations thereof. For example, in an embodiment of interstitially insulated pipe 100 comprising an inner steel pipe 125 have substantially the same outer diameter as the inner diameter of an outer steel pipe 135, and a stainless steel screen mesh 151, screen mesh 151 is be carefully wrapped around the outside surface of inner pipe 125 and spot welded to the outside surface of inner pipe 125 in suitable locations to hold screen mesh 125 in place. Then, inner pipe is cooled and outer pipe 135 is heated. Next, inner pipe 125, including the attached screen mesh 151, is slid coaxially within outer pipe 135. Once inner pipe 125 and attached screen mesh 151 are disposed coaxially within outer pipe 135, outer pipe 135 is allowed to cool and shrink fit around screen mesh 151 and inner pipe 125 to form the embodiment of interstitially insulated tubular 100.

A hydrostatic pressure technique may be used as an alternate manufacturing method. For example, in one embodiment of interstitially insulated pipe 100, outer pipe 135 is made of a carbon steel pipe and inner pipe 125 is made of a carbon steel pipe with an outside diameter less than the inside diameter of outer pipe 135. Further, screen mesh 151 is a stainless steel mesh whose width is about the same as the interior circumference of the outer pipe 135. Screen mesh 151 may be installed on the inside surface of outer pipe 135. Then, inner pipe 125 is slipped coaxially into the outer tubular and screen mesh 125. Next, a hydrostatic pressure process or other technique is used to expand inner pipe 125 into screen mesh 151 to provide interstitially insulated tubular 100.

In still one further exemplary manufacturing method for interstitially insulated pipe 100, inner pipe 125 (e.g., a standard 40 foot subsea pipe segment) is spiral wound with a roll (e.g., 1 to 2 foot wide roll) of reflective material (e.g., aluminized MYLAR®, aluminum, etc.) in a first direction, and then spiral wound with a roll of screen mesh 151 (e.g., a 1 to 2 foot wide roll) in the a second direction that is opposite the first direction. Next an intermediate layer or shim layer is spiral wound on the screen mesh 151 in the first direction on the screen mesh 151. This process may be repeated until the desired number of layers of screen mesh, and hence desired radial thickness dᵢ for insulating interstice 127, is achieved. Once the windings are complete, outer pipe 135 may be slip fit coaxially about inner pipe 125, layers of screen mesh 151, and any shim or intermediate layers.

As previously described, embodiments of interstitially insulated pipes described herein (e.g., interstitially insulated tubulars 100, 200, 300) may be used to form a pipeline (e.g., subsea pipeline) to transport and insulate a fluid. To build or construct such a pipeline, segments of the interstitially insulated pipe may be connected or coupled end-to-end to form a continuous single pipeline extending over the desired distance. To maintain the insulating capabilities of the pipeline, preferably the connections or couplings between the individual interstitially insulated pipe segments are sufficiently insulated. Likewise, the couplings or connections between the individual interstitially insulated pipe segments preferably include a fluid tight seal that restricts fluid communication between the fluid flowing within the pipeline (e.g., within region 120) and the region outside the pipeline (e.g., region 130), and restricts fluid communication between the insulating interstice (e.g., interstice 127) and the environment outside the pipeline. Otherwise, leakage of the fluid being transported (e.g., crude oil) may occur, and further, the insulting capability of the pipeline may be compromised.

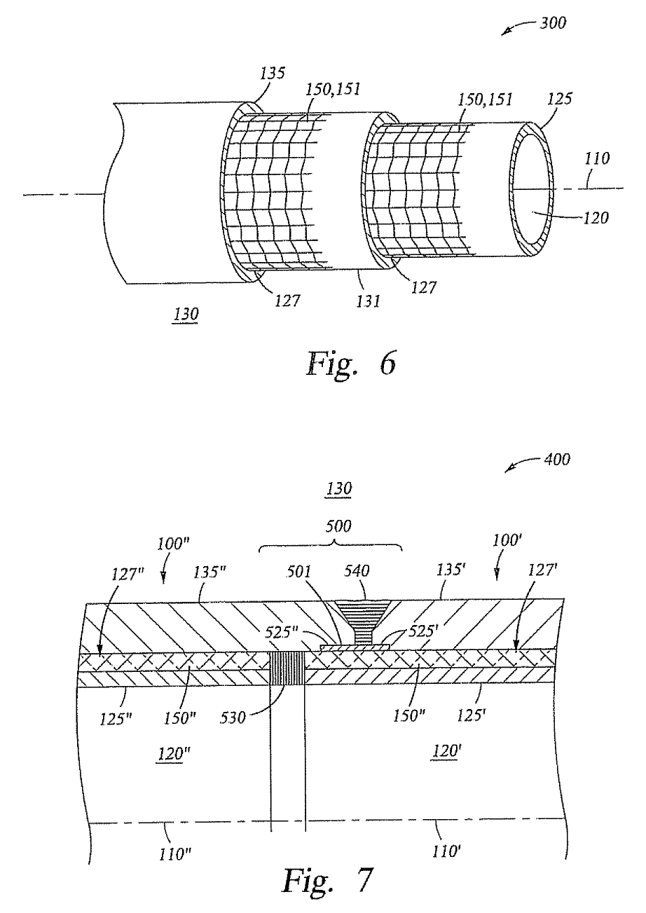

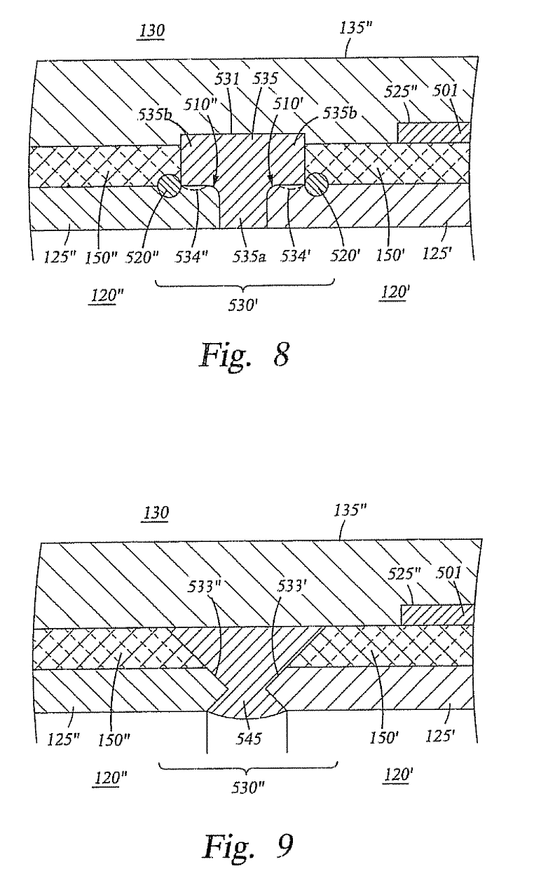

Referring now to FIG. 7, an enlarged partial cross-sectional view of a tubular assembly or pipeline 400 is shown. Pipeline 400 comprises a first interstitially insulated pipe 100′ coupled to a second interstitially insulated pipe 100″ end-to-end by a joint or coupling 500. Interstitially insulated pipes 100′, 100″ are substantially the same as interstitially insulated pipe 100 previously described with reference to FIGS. 1 and 2, each comprising an inner pipe 125′, 125″, and outer pipe 135′, 135″, an insulating interstice 127′, 127″, and a separator 150′, 150″, respectively. In particular, joint 500 couples pipes 100′, 100″ axially end-to-end and such that inner regions 120′, 120″, respectively, are in fluid communication, thereby forming a continuous flow passage for the fluid transported by pipeline 400. It is to be understood that any number of interstitially insulated pipes 100′, 100″ may be coupled axially end-to-end by joint(s) 500 to form a pipeline 400 of the desired length. In the embodiment illustrated in FIG. 7, with regard to first interstitially insulated pipe 100′ (right side of FIG. 8), both separator 150′ and inner pipe 125′ extend axially beyond the end of outer tubular 135′. More specifically, separator 150′ and inner pipe 125′ each preferably extend beyond outer pipe 135′ by at least four times the radial thickness of separator 150′. Conversely, with regard to second interstitially insulated pipe 100″ (left side of FIG. 8), outer pipe 135′ extends axially beyond the ends of both separator 150″ and inner pipe 125″ (i.e., separator 150″ and inner pipe 125″ are each recessed within outer pipe 135″). In particular, separator 150″ and inner pipe 125″ are recessed by about the same axial length that separator 150′ and inner pipe 125′ extend from outer pipe 135′. In this configuration, pipeline 400 and joint 500 may generally be formed by sliding the extensions of separator 150′ and inner pipe 125′ of first interstitially insulated pipe 100′ within outer pipe 135″ of second interstitially insulated pipe 100″. When pipeline 400 is formed, interstitially insulated pipes 100′, 100″ share the same central axis 110′, 110″.

Referring still to FIG. 7, in this embodiment, joint 500 comprises an annular thermal insulator 501, an radially outer connection 540, and a radially inner seal assembly 530. Thermal insulator 501 is thin-walled cylindrical band disposed beneath connection 540, radially between the inner surfaces of outer pipes 135′, 135″ and separator 150′. Thus, thermal insulator 501 extends axially along the inside surface of a portion of each outer pipe 135′, 135″, and thus, bridges the gap between the ends of pipes 135′, 135″ along their inner surfaces. In this embodiment, recesses 525′, 525″ are provided along the inner surfaces of outer pipes 135′, 135″ at their ends. Recesses 525′, 525″ are sized to mate with and accommodate thermal insulator 501. Recesses 525′, 525″ may be cast or molded as part of outer pipes 135′, 135″ or machined into outer pipes 135′, 135″. Thermal insulator 501 may be disposed within recesses 525′, 525″ manually (e.g., thermal insulator is a solid material) or by potting and curing thermal insulator 501 within recesses 525′, 525″.

Thermal insulator 501 provides a physical barrier between first region 120 and second region 130, thereby restricting the flow of fluids therebetween. For instance, in some embodiments, thermal insulator 501 sealingly engages the inside surfaces of outer pipes 135′, 135″ (e.g., sealingly engages recesses 525′, 525″) to prevent the flow of fluids between first region 120 and second region 130. In such embodiments, thermal insulator 501 may prevent potentially corrosive fluids flowed through region 120 from contacting connection 540 and the portions of outer pipes 135′, 135″ proximal connection 540. In addition, thermal insulator 501 provides a thermal barrier between first region 120 and second region 130, thereby restricting the flow of thermal energy (e.g., heat) between first region 210 and second region 130.

Still referring to FIG. 7, connection 540 axially joins or couples the ends of outer pipes 135′, 135″. Connection 540 preferably provides a 360° circumferential fluid tight seal preventing fluid communication between interstice 127′ and second region 130, and between first region 120 and second region 130. For instance, in embodiments where pipeline 400 is a subsea crude oil or natural gas pipeline, connection 540 preferably prevents leakage of such crude oil or natural gas from first region 120 into the surrounding sea water in second region 130. In addition, connection 540 preferably provides a relatively rigid, strong connection between outer pipes 135′, 135″, thereby preventing first interstitially insulated pipe 100′ and second interstitially insulated pipe 100″ from being pulled apart when pipeline 400 is subject to axial tensile forces. In general, connection 540 may be formed by any suitable means including without limitation welding (e.g., if outer pipes 135′, 135″ comprise metals), a pressure fit connection, an adhesive, mating threads, or combinations thereof. However, for subsea pipeline applications, connection 540 is preferably formed by welding. In such welded embodiments, connection 540 may be formed by employing a consumable welding insert located between outer pipe 135′ and outer pipe 135″ and then welding the consumable insert to rigidly connect outer pipe 135′ and outer pipe 135″. Connection 540 is preferably formed after inner pipe 125′ and separator 150′ have been sufficiently inserted within outer pipe 135″ such that ends of outer pipes 135′, 135″ are generally adjacent each other.

In embodiments where connection 540 is a welded joint, thermal insulator 501 also provides protection to underlying components of tubular assembly 400 (e.g., separator 150′, inner pipe 125′, seal assembly 530, etc.) which may otherwise be detrimentally damaged by heat induced by the welding of outer pipe 135′ to outer pipe 135″ to form connection 540. For instance, if connection 540 is formed by arc welding and separator 150′ is a metal screen mesh, without thermal insulator 501, such welding may melt portions of separator 150′, thereby increasing the contact surface area between outer pipes 135′, 135″ and inner pipes 125′, 125″ and detrimentally increasing the thermal conductivity of pipeline 400 proximal connection 540.

Referring still to FIG. 7, seal assembly 530 is disposed between the ends of separator 150′ and inner pipe 125′ of first interstitially insulated pipe 100′ and the ends of separator 150″ and inner pipe 125″ of second interstitially insulated pipe 100″, respectively. Like thermal insulator 501, seal assembly 530 preferably has a relatively low thermal conductivity. In other words, seal assembly 530 preferably does not significantly compromise the insulating capabilities of interstitially insulated pipes 100′, 100″ or pipeline 400. Further, seal assembly 530 preferably sealingly engages separators 150′, 150″ and inner pipes 125′, 125″, thereby restricting the flow of fluids between first region 20 and interstices 127′, 127″.

In this embodiment, seal assembly 530 is formed as inner pipe 125′ and separator 150′ are axially advanced into outer pipe 135″ and sufficiently engage inner pipe 125″ and separator 150″. For instance, seal assembly 530 may comprise a pliable (or rigid) annular sealing member that is configured to mate with the ends of inner pipes 125′, 125″ and mate with the ends of separators 150′, 150″. Exemplary embodiments of seal assembly 530 are discussed in more detail below.

In general, thermal insulator 501 may comprise any suitable material including without limitation ceramics, polymers, composites, or combinations thereof. It should be appreciated that the choice of materials for thermal insulator 501 may depend on a variety of factors including without limitation the desired thermal conductivity of thermal insulator 501, the manner in which connection 540 is formed (e.g., whether connection 540 is formed by heat intensive methods such as welding, etc.), the material composition of separator 150′ (e.g., whether separator 150′ is a metal screen mesh, a polymer material, etc.), the degree of flexibility desired of thermal insulator 501 (e.g., the degree to which thermal insulator 501 needs to be formed or shaped into a particular configuration), the desired strength of thermal insulator 501 (e.g., the ability of the material to withstand bending, the ability of the material to withstand impact loads, etc.), or combinations thereof. Preferably, thermal insulator 501 has a thermal conductivity less than or equal to separators 150′, 150″. As previously discussed, in embodiments where connection 540 is formed by heat intensive methods (e.g., welding), thermal insulator 501 may be selected to provide performance compatibility with the method and associated heat, as well as provide protection to components of pipeline 400 underlying thermal insulator 501 (e.g., separator 150′).

In subsea applications where connection 540 is preferably formed by welding, thermal insulator 501 preferably comprises a ceramic material, such as AREMCO Lox Series Ceramics available from AREMCO Products, Inc. of Valley Cottage, N.Y., USA, or a polymer such as glass-filled polytetrafluoroethylene (TEFLON®) available from DuPont. Ceramic materials may be preferred due to their relatively low thermal conductivity, their ability to withstand high temperatures (e.g., provide protection to separator 150′ when connection 540 is formed by welding), their ability to be configured and shaped with relative ease by molding, potting, and/or machining, and their toughness (e.g., even if cracked or shattered from bending or impact loads, the trapped ceramic material may still provide suitable insulation). Similarly, polymers may be preferred due to their relatively low thermal conductivity, their relatively high melting temperature (e.g., to withstand high temperatures and provide protection to separator 150′ when connection 540 is formed by welding), their ability to be configured and shaped with relative ease by molding (e.g., thermoset or thermoflow), and/or machining, and their flexibility (e.g., ability to provide thermal resistance under bending or impact loads).

Although recesses 525′, 525″ are shown in FIG. 7 to accommodate thermal insulator 501, in other embodiments, recesses may not be provided, but rather, thermal insulator 501 is press fit or wedged radially between the outer pipes (e.g., outer pipes 135′, 135″) and the separator (e.g., separator 150′) generally beneath the connection between the outer pipes (e.g., connection 540). Further, in other embodiments (not illustrated), a recess or counter bore may be provided in the outer surface of separator 150′ to accommodate thermal insulator 501. Alternatively, in select embodiments, thermal insulator 501 may replace a portion of separator 150′. In still other embodiments, thermal insulator 501 may be integral with separator 150′. For instance, if separator 150′ is a screen mesh, thermal insulator 501 may comprise a combination of the screen mesh and an insulating material (e.g., ceramic material, polymer, etc.) disposed within the holes and gaps of the screen mesh. In such an example, the insulating material may be emplaced in the holes of the screen mesh by potting and then allowed to cure in situ.

Referring now to FIG. 8, an enlarged schematic cross-sectional view of an exemplary embodiment of a seal assembly 530′ is shown. Seal assembly 530′ may be employed as seal assembly 530 previously described with respect to FIG. 8. In this embodiment, seal assembly 530′ comprises an annular seal member 535 axially disposed between the ends of separators 150′, 150″ and inner pipes 125′, 125″. In this embodiment, an annular recess 531 is provided in the inner radial surface of outer pipe 135″ to accommodate the radially outermost portion of seal member 535. Groove 531 may be molded or cast as part of outer pipe 135″ or machined into the inner radial surface of outer pipe 135″. In different embodiments, no groove 531 is provided in the inner surface of outer pipe 135″ to accommodate seal member 535.

The annular seal member 535 illustrated in FIG. 8 has a general T-shaped cross-section including a radially inner base 535a and radially outer axial extensions 535b. Inner pipes 125′, 125″ extend slightly beyond the ends of separators 150′, 150″, respectively, such that inner pipes 125′, 125″ engage base 535a of seal member 535, and separators 150′, 150″ engage the axial ends of extensions 535b of seal member 535. More specifically, as the ends of inner pipes 125′, 125″ engage base 535a of seal member 535, the outer radial surface of each pipe 125′, 125″ slidingly engages the radially inner surface of extensions 535b of seal member 535 to form sliding seals 510′, 510″, respectively, therebetween. The radially outer surface of pipes 125′, 125″ proximal their ends are preferably manufactured or machined smooth to enhance the seal formed at sliding seals 510′, 510″. In some embodiments, a sealing cap (not shown) may be provided over the end of each inner pipe 125′, 125″ to form sliding seals 510′, 510″, respectively. Sliding seals 510′, 510″ serve to further restrict the flow of fluids between inner regions 120′, 120″ and insulating interstice 127′, 127″.

Since sliding seals 510′, 510″ are formed as the radially outer surface of the ends of inner pipes 125′, 125″ slidingly engage the radially inner surface of extensions 535b, sliding seals 510′, 510″ allow for some dimensional variation in the actual axial lengths of inner pipes 125″, 125″, as well as minor axial length changes that may occur due to thermal expansion/shrinkage of materials upon heating/cooling, while maintaining sufficient engagement between inner pipes 125′, 125″ and seal member 535.

In other embodiments, a groove including an o-ring type seal may also be included between seal member 535 and each inner pipe 125′, 125″ to further enhance the seal formed therebetween. Further, in some embodiments, a gap 534′, 534″ (shown in phantom in FIG. 9) may be provided between a portion of seal member 535 and inner pipes 125″, 125″. Gap 534′, 534″ may include air or other insulating medium insulator to further enhance the insulating capabilities of seal assembly 530.

Still referring to the embodiment shown in FIG. 8, the ends of inner pipe 125′ and separator 150′ are coupled together by one or more bonds 520′. Likewise, the ends of inner pipe 125′″ and separator 150″ are coupled together by one or more bonds 520″. Bonds 520′, 520″ advantageously maintain the orientation of inner pipe 125′ and separator 150′ adjacent each other and maintain the orientation of inner pipe 125″ and separator 150″ adjacent each other respectively, during assembly of pipeline 400. In addition, bonds 520′, 520″ offer the potential to enhance sealing between inner pipes 125′, 125″ and seal member 535 by increasing the contact surface area therebetween. This may be particularly preferred when it is desirable to prevent fluids flowing in first region 120 from reaching separator 150′, 150″. For example, if separator 150′, 150″ is susceptible to corrosion and the fluid in first region 120 is corrosive, it may be desirable to maintain complete separation of such fluid and separator 150′, 150″ via seal member 535, sliding seals 510′, 510″, and bonds 520′, 520″. In embodiments where inner pipes 125′, 125″ and separators 150′, 150″ comprises metals, bonds 520′, 520″ preferably comprise a welded connection. However, in other embodiments, an adhesive, a clip, or other suitable means may be used to form bonds 520′, 520″.

In general, seal member 535 may comprise any suitable low thermal conductivity material including, without limitation, a polymer (e.g., glass-filled polytetrafluoroethylene, TEFLON®), a ceramic (e.g., AREMCO Lox Series Ceramics), a ceramic foam, glass nanospheres as previously described, titanium dioxide, or combinations thereof. Preferably, seal member 535 comprises a high temperature polymer. Further, preferably seal member 535 comprises a material capable of sealingly engaging inner pipes 125′, 125″ and separators 150′, 150″ to create a fluid tight seal.

Referring now to FIG. 9, a schematic illustration of another exemplary embodiment of a seal assembly 530″ is shown. Seal assembly 530″ may be used as seal assembly 530 previously described with respect to FIG. 8. In this embodiment, seal assembly 530″ comprises an annular seal member 545 having a cross-sectional shape including generally concave lateral side surfaces 533′, 533″ adapted to mate with the ends of separators 150′, 150″ and inner pipes 125′, 125″. In particular, concave lateral side surfaces 533′, 533″ of seal member 545 are generally V-shaped. Surface 533′ of seal member 540 acts to wedge separator 150′ and inner pipe 125′ together when separator 150′ and inner pipe 125′ engage and axially advanced against seal member 540. Similarly, surface 533″ of seal member 535 acts to wedge separator 150″ and inner pipe 125″ together when separator 150″ and inner pipe 125″ engage and are axially advanced against seal member 535.

Referring now to FIGS. 7-9, in an embodiment, field preparation of pipeline 400 may be initiated by positioning seal member 535, 545 either against inner pipe 125′ and separator 150′, or against inner pipe 125″ and separator 150″. In the embodiments illustrated in FIG. 8, seal member 535 may be disposed in groove 531 provided in the inside surface of outer pipe 135″, with axial extension 535b at least partially engaging bonds 520′, 520″, respectively. In the embodiment illustrated in FIG. 9, seal member 545 may be positioned such that V-shaped surface 533′ at least partially engages the ends of inner pipe 125′ and separator 150′ or V-shaped surface 533″ at least partially engages the ends of inner pipe 125″ and separator 150″. In some embodiments, seal member 535, 545 may be coupled to inner pipe 125′ and separator 150′, or coupled to inner pipe 125″ and separator 150″, such that seal member 535, 545 is maintained in place during assembly of pipeline 400.

At about the same time, annular thermal insulator 501 may be placed around separator 150′ and disposed within recess 525′ extending beyond the end of outer pipe 135′, or as an alternative, potted and cured in recess 525′ and extending beyond the end of outer pipe 135′. In still different embodiments, thermal insulator 501 may be potted and cured within recesses 525′, 525″ after inner pipe 125′ and separator 150′ are positioned sufficiently within outer pipe 135″ and prior to forming connection 540. In such embodiments, thermal insulator may be cured with the subsequent heat (e.g., from welding in the case connection 540 is formed by welding), or in the alternative, from a heating tool inserted from an open end of pipeline 400. It is to be understood that once connection 540 is formed, recesses 525′, 525″ are no longer accessible.

Next, the portions of separator 150′ and inner pipe 125′ extending beyond the end of outer pipe 135′ may be coaxially inserted and advanced into outer pipe 135″ of second interstitially insulated pipe 100″. As previously described, inner pipes 125′, 125″ and separators 150′, 150″ are pushed together until sealing assembly 530 is sufficiently formed (i.e., seal member 535, 545 is sufficiently engaged by the ends of separators 150′, 150″ and inner pipes 125′, 125″). A moderate axial compressive force may then be applied to slightly force the proper engagement of seal member 535, 545 with the ends of inner pipes 125′, 125″ and separators 150′, 150″, thereby forming seal assembly 530.

In embodiments where inner pipes 125′, 125″ are metal, inclusion of seal assembly 530 between separators 150′, 150″ and between inner pipes 125′, 125″ is preferred to simply welding inner pipes 125′, 125″ together for a variety of reasons. For instance, welding inner pipes 125′, 125″ together may melt or damage portions of separators 150′, 150″, potentially reducing the insulating capabilities of insulating interstices 127′, 127″ and the overall insulating capabilities of pipeline 400. In addition, in many subsea applications, the pipeline (e.g., pipeline 400) is fabricated one pipe segment at a time (e.g., one interstitially insulated pipe 100 at a time) on a barge, and subsequently submersed subsea as it is fabricated. In cases where tens or hundreds of miles of pipeline are necessary, requiring hundreds or even thousands of individual pipe segments, the extra step of welding the inside of each successive pipe segment takes additional time, effort, and expense.

Once seal assembly 530 is sufficiently formed, connection 540 is employed to securely and reliably connect first interstitially insulated pipe 100′ and second interstitially insulated pipe 100″, thereby completing the formation of joint 500. This process may be repeated to add additional interstitially insulated pipes (e.g., pipes 100) end-to-end until pipeline 400 obtains the desired length.

Without being limited by this or any particular theory, embodiments of pipeline 400 and joint 500 resulting from the partial overlap of layers of first interstitially insulated pipe 100′ (e.g., separator 150′, inner pipe 125′, outer pipe 135′, etc.) with at least some of the layers of second interstitially insulated pipe 100″ (e.g., separator 150″, inner pipe 125″, outer pipe 135″, etc.) tend to be structurally stronger than embodiments in which there is no overlapping of layers between interstitially insulated pipes 100′, 100″ (e.g., embodiments where interstitially insulated pipes 100′, 100″ is connected end-to-end with by a simple butt joint therebetween).

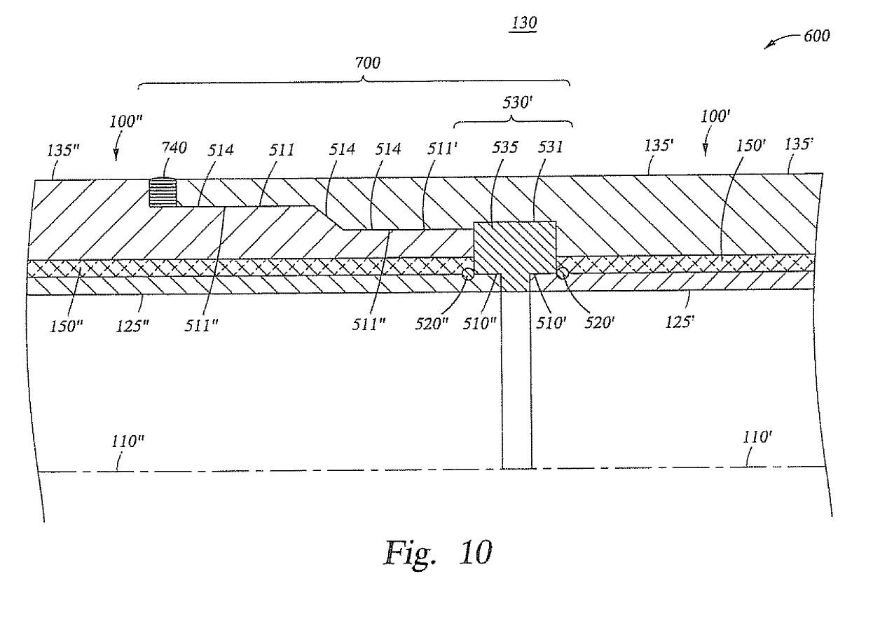

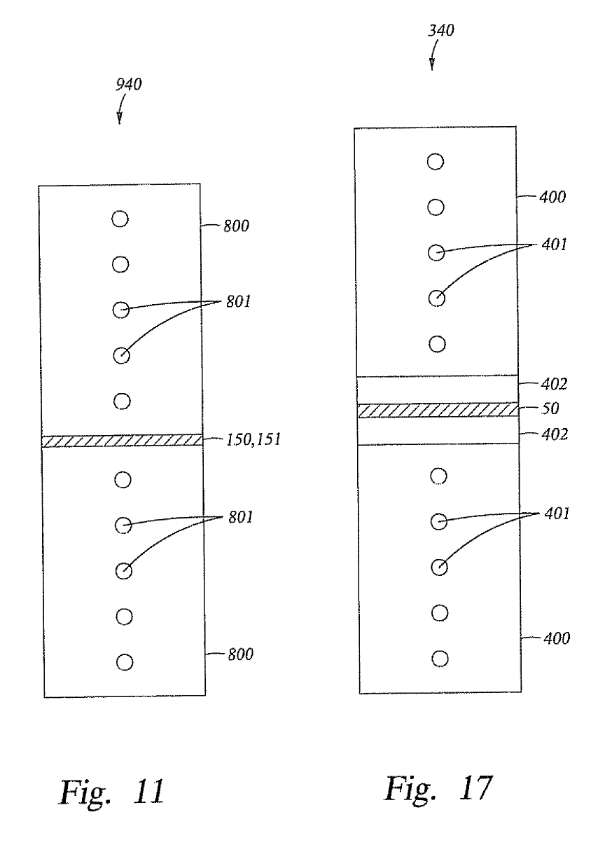

Referring now to FIG. 10, an enlarged partial cross-sectional view of another embodiment of a pipeline 600 is illustrated. Pipeline 600 comprises a first interstitially insulated pipe 100′ axially coupled to a second interstitially insulated pipe 100″ by a joint 700. Interstitially insulted pipes 100′, 100″ are substantially the same as interstitially insulated pipe 100 previously described with reference to FIGS. 1 and 2. Joint 700 coupled or joins first interstitially insulated pipe 100′ and second interstitially insulated pipe 100″ without significantly compromising the insulating capabilities of pipeline 600 or interstitially insulated tubulars 200′, 200″. Namely, each interstitially insulated pipes 100′, 100″ includes an outer pipe 135′, 135″, an inner pipe 125′, 125″ an insulting interstice 127′, 127″, and a separator 150′, 150″, respectively.

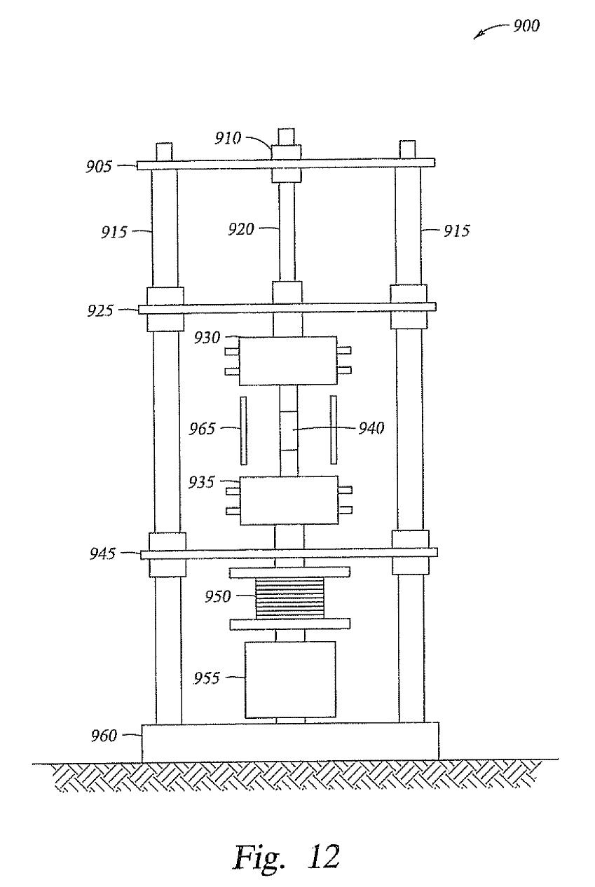

With regard to second interstitially insulated pipe 100″ (on the left in FIG. 10), the outer radial surface of outer pipe 135″ includes two steps 511″. At each step 511″, moving left to right in FIG. 10, the outside radius of outer pipe 135″ is decreased. Although outer pipe 135″ illustrated in FIG. 11 includes two steps 511″, in general, one or more steps 511″ may be provided in the outer radial surface of outer pipe 135″. With regard to first interstitially insulated pipe 100′ (on the right in FIG. 10), outer pipe 135′ extends beyond separator 150′ and inner pipe 125′. Further, the inside surface of the portion of outer pipe 135′ extending beyond separator 150′ and inner pipe 125′ includes two steps 511′ generally configured to mate with steps 511″ formed in outer pipe 135″ of second interstitially insulated pipe 100″. Thus, at each step 511′, moving left to right in FIG. 11, the inner radial diameter of outer pipe 135′ is decreased. Although outer pipe 135′ illustrated in FIG. 12 includes two steps 511′, in general, one or more steps 511′ may be provided in the outside surface of outer pipe 135′. Preferably the number, size, and radial locations of steps 511′, 511″ are configured and oriented such that they mate when interstitially insulated pipes 100′, 100″ are coupled as shown in FIG. 10. Steps 511″ may be cast or molded as part of outer pipes 135′, 135″ or may be machined from outer pipes 135′, 135″.

Accordingly, in this configuration, pipeline 600 and joint 700 are formed by sufficiently inserting the reduced outside diameter portions of second interstitially insulated pipe 100″ into the mating reduced inside diameter portions of first interstitially insulated pipe 100′. Seal assembly 530′ is disposed between the ends of separators 150′, 150″ and the ends of inner pipes 125′, 125″. In this embodiment, seal assembly 530′ is substantially the same as that shown in FIG. 9. However, in other embodiments, seal assembly 530′ may have a different configuration (e.g., similar to that shown in FIG. 9). As previously described, seal assembly 530′ preferably has a relatively low thermal conductivity, and further, seal assembly 530′ preferably sealingly engages the ends of separators 150′, 150″ and the ends of inner pipes 125′, 125″, thereby reducing and/or preventing the flow of fluids between first regions 120′, 120″ and second region 130.

Referring still to FIG. 10, additional sealing surfaces 514 are formed at the radially overlapping portions of outer pipe 135′ and outer pipe 135″. Some of these sealing surfaces 514 are formed at the interface of mating steps 511′, 511″. In this embodiments, sealing surfaces 514 result simply from the sliding engagement of the surfaces of outer pipes 135′, 135″. However, in other embodiments, additional seals or sealing assemblies (e.g., o-ring) may be provided at one or more interfaces between outer pipes 135′, 135″. Further, in still other embodiments, one or more layers of an insulating material (e.g., high temperature epoxy, layer of polypropylene, etc.) may be placed between the interfacing surfaces of outer pipes 135′, 135″. Preferably any additional material(s) placed along the interfaces between outer pipes 135′, 135″ (e.g., between steps 511′ and steps 511″) comprise a relatively low thermal conductivity, preferably less than or equal to the thermal conductivity of separators 150′, 150″. In some embodiments, recesses may be provided to accommodate any additional seals, insulators, or materials provided between outer pipes 135′, 135″. Still further, in some embodiments, mating threads may be provided along one or more steps 511′, 511″ to enable threaded coupling of interstitially insulated pipes 100′, 100″. Such threads offer the potential to enhance the engagement of pipes 100′, 100″, and also offer the potential to enhance the sealing ability of joint 700.

Still referring to FIG. 10, a connection 740 couples outer pipes 135′, 135″. Connection 740 is similar to connection 540 described with reference to FIG. 7. Accordingly, connection 740 may be formed by a variety of suitable means including without limitation welding (e.g., if outer pipe 135′ and outer pipe 135″ are both metals), an interference fit connection, a pressure fit connection, an adhesive, mating threads, or combinations thereof. In subsea applications, connection 740 is preferably a 360° circumferential weld entirely around the outside of pipeline 600. Connection 740 preferably provides a fluid tight seal preventing the flow of fluids between first region 120 and second region 130, and further, preferably provides a relatively strong connection between interstitially insulated pipes 100′, 100″.

In general, connection 740 is formed after the male-shaped end of second interstitially insulated pipe 100″ is sufficiently disposed within the female-shaped end of first interstitially insulated pipe 100′ such that outer pipe 135′ and outer pipe 135″ are sufficiently close to be physically connected by connection 740.

Preferably any additional seals, insulators, or materials placed between outer pipe 135′ and outer pipe 135″ proximal connection 740 are either compatible with the method of forming connection 740 (e.g., welding) or shielded from the method of forming connection 740. For instance, if connection 740 is formed by welding and a screen mesh separator is placed between outer pipe 135′ and outer pipe 135″ proximal connection 740, a thermal insulator (e.g., thermal insulator 501 illustrated in FIG. 8) may be provided between connection 740 and the screen mesh in order to protect the screen mesh from being damaged or otherwise comprising the insulating capabilities of pipeline 600. Field assembly of pipeline 600 shown in FIG. 11 may be performed similarly to pipeline 400 previously described.

If necessary, greater flexibility for pipelines 400, 600 previously described may be achieved by varying the component materials of each interstitially insulated pipe segment and/or by varying the geometry of the component materials of each interstitially insulated pipe segment. For instance, by reducing the radial thickness of outer pipes 135′, 135″ and/or inner pipes 125′, 125″, pipeline 400, 600 may be made more flexible.

In the manner described, embodiments described herein provide improved pipes, pipe segments, and pipelines for insulating a fluid flowing therein. In addition, embodiments described herein provide interstitially insulated pipes or pipe segments that may be connected end-to-end by joints to form a pipeline having substantially the same thermal resistance and insulating capabilities as each of the individual pipe segment. Although embodiments described herein have shown particular application in subsea hydrocarbon pipelines, other applications are possible.

While preferred embodiments have been shown and described, modifications thereof can be made by one skilled in the art without departing from the scope or teachings herein. The embodiments described herein are exemplary only and are not limiting. Many variations and modifications of the system and apparatus are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims.

### Example 1

To quantify the thermal resistance and insulting capabilities of a variety of screen meshes, controlled experiments were conducted. The experimental conditions were appropriate for simulating deepwater pipeline applications. Steel slugs made of the same material as subsea pipes (“X-60 or X-80” pipe or low alloy steel AISI 4130 or API Spec 5cT-P110) were used to represent the subsea pipe walls.

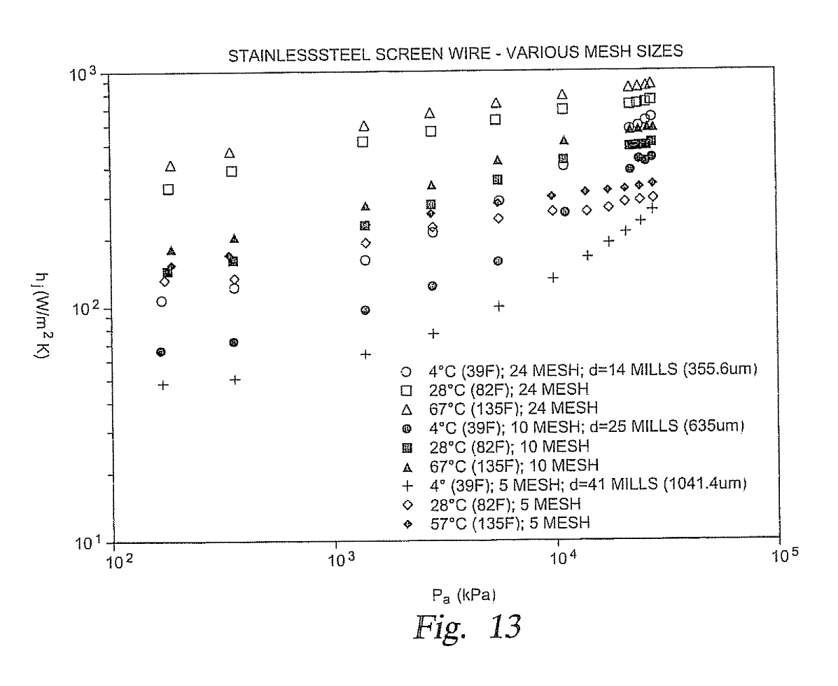

As illustrated in FIG. 12, each test specimen 940 comprised two flux meters 800 and a screen mesh 151 positioned between the flux meters 800. The flux meters 800 were fabricated from the steel slugs previously described. Each flux meter 800 had a length of about 1.5 in.˜(3.81 cm). Five equally spaced holes 801 were drilled to the center of each steel flux meter 800 in order to affix “T” type thermocouples (not shown). The thermocouples measured the temperature in the flux meter 800 at various distances from screen mesh 151 during testing. Cutouts of screen mesh 151 having a diameter of 1 in. (˜2.54 cm) were pressed between the two flux meters 800 by the Thermal Contact Conductance (TCC) system 900 illustrated in FIG. 13 and described below.

FIG. 13 illustrates the Thermal Contact Conductance (TCC) system 900 used to conduct the experiments. The TCC system 900 comprises a top plate 905, a lock nut 910, a guide shaft 915, a threaded rod 920, an upper moveable plate 925, a heat source 930, a heat sink 935, a test specimen 940, a lower moveable plate 945, a load bellows 950, a load cell 955, a base plate 960, and a radiation shield 965. The heat source 930 was fastened to the upper moveable plate 925. The temperature of the heat source 930 was controlled according to the desired test parameters. The heat sink 935 was fastened to the lower moveable plate 945. The temperature of the heat sink 935 was controlled according to the desired test parameters. The test specimen 940 was held between the heat source 930 and heat sink 935. To properly position the specimen 940 between the heat source 930 and heat sink 935, the upper moveable plate 925 and heat source were moved, by rotating threaded rod 920 connected to upper moveable plate 925, until the test specimen 940 contacted the heat source 930 and heat sink 935. The linear movement of upper moveable plate 925 and heat source 930 were guided by guide shaft 915. Once the test specimen 940 was properly positioned between the heat source 930 and heat sink 935, the upper moveable plate 925 was fixed by tightening lock nut 910. The radiation shield 965 was provided around the test specimen 940 to minimize radial heat losses. In addition, the test specimen 940 was wrapped by a secured foam insulation cover (not shown) to minimize convective heat losses, and thus ensure that the applied heat flow, from heat source 930 to heat sink, was one dimensional along the radial axis of test specimen 940.

To begin the experiment, the test specimen 940 was loaded by introducing pressure into the load bellows 950, mounted to lower moveable plate 945. The load bellows 950 provided a linear load to lower moveable plate 945 and heat sink 935. This linear load was transferred across the test specimen 940. The load cell 955 was used to determine the pressure across the test specimen 940 (i.e., pressure at the surface interfaces of the screen mesh tested). Five “T” type thermocouples (not shown) were affixed to the centerline of each flux meter to measure temperature differentials.

A control system (not shown) controlled and adjusted the temperatures and pressure until the desired test conditions were met. The control system also collected and stored all the temperature and pressure data for the experiment.

The environment around test specimen 940 may have been entirely evacuated if necessary, thus minimizing convection heat transfer. However, these experiments were run with an ambient environment, and therefore air was present in the gaps formed by the contacting surface and screen mesh.

Table 1 below summarizes the experimental parameters used to ascertain the overall thermal resistance resulting from the insertion of the screen mesh 151 between the two separated steel flux meters 800 with air as the interstitial medium (i.e., air filled the gaps 152 and holes 154 in the screen mesh). 800800 The experimental study encompassed a range of interface pressures and temperatures.

TABLE 1

| Screen | | Wire | | | | Mean |
|---|---|---|---|---|---|---|
| Mesh | Mesh | Diameter | | Outer | Inner | Interface |
| Material | Number | (cm) | Interface Pressure (kPa) | Temp (C.) | Temp (C.) | Temp (C.) |
| Stainless | 5 | 0.10414 | 172.4, 344.7, 517.1, 689.5, | 0 | 93.3 | 16.7, 46.7, |
| Steel | | | 1034.2, 1379, | | | 86.7 |
| | | | 1723.7, 2068.4, 2758, 3447.4 | | | |
| Stainless | 10 | 0.0635 | 172.4, 344.7, 517.1, 689.5, | 0 | 93.3 | 16.7, 46.7, |
| Steel | | | 1034.2, 1379, | | | 86.7 |
| | | | 1723.7, 2068.4, 2758, 3447.4 | | | |
| Stainless | 24 | 0.03556 | 172.4, 344.7, 517.1, 689.5, | 0 | 93.3 | 16.7, 46.7, |
| Steel | | | 1034.2, 1379, | | | 86.7 |
| | | | 1723.7, 2068.4, 2758, 3447.4 | | | |
| Titanium | 9 | 0.08128 | 172.4, 344.7, 517.1, 689.5, | 0 | 93.3 | 16.7, 46.7, |
| | | | 1034.2, 1379, 1723.7, 2068.4, | | | 86.7 |
| | | | 2758, 3447.4 | | | |
| Titanium | 14 | 0.04064 | 172.4, 344.7, 517.1, 689.5, | 0 | 93.3 | 16.7, 46.7, |
| | | | 1034.2, 1379, 1723.7, 2068.4, | | | 86.7 |
| | | | 2758, 3447.4 | | | |
| Titanium | 18 | 0.02794 | 172.4, 344.7, 517.1, 689.5, | 0 | 93.3 | 16.7, 46.7, |
| | | | 1034.2, 1379, 1723.7, 2068.4, | | | 86.7 |
| | | | 2758, 3447.4 | | | |
| Tungsten | 8 | 0.0254 | 172.4, 344.7, 517.1, 689.5, | 0 | 93.3 | 16.7, 46.7, |
| | | | 1034.2, 1379, 1723.7, 2068.4, | | | 86.7 |
| | | | 2758, 3447.4 | | | |
| Tungsten | 20 | 0.0127 | 172.4, 344.7, 517.1, 689.5, | 0 | 93.3 | 16.7, 46.7, |
| | | | 1034.2, 1379, 1723.7, 2068.4, | | | 86.7 |
| | | | 2758, 3447.4 | | | |

The experimental results compared the overall heat transfer coefficient (hⱼ) to the interface pressure and temperature. In general, the lower the overall heat transfer coefficient (hⱼ), the greater the overall thermal resistance and the greater the insulating capability.

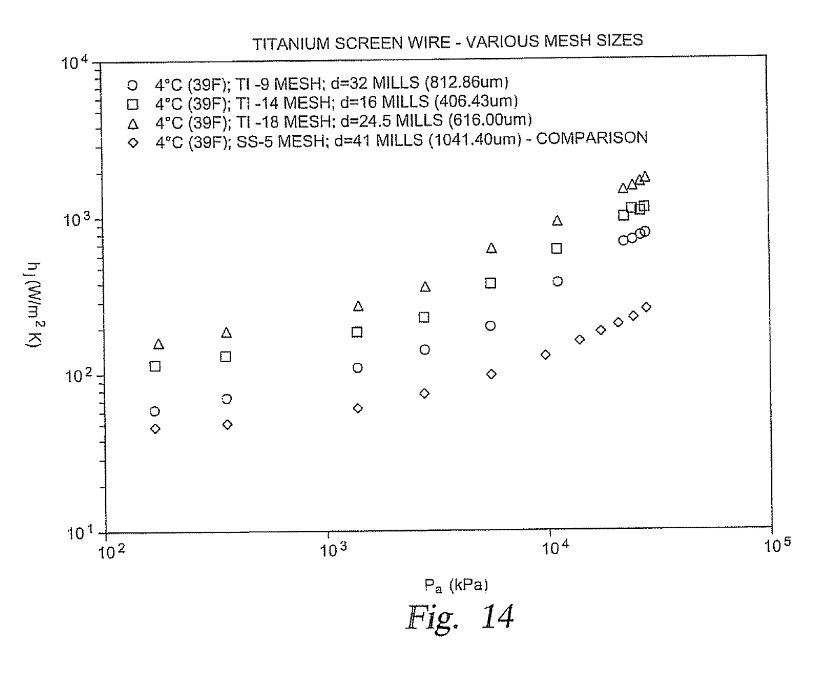

FIG. 14 graphically illustrates the results for the stainless steel screen mesh specimens shown in Table 1. The screen mesh with the lowest overall heat transfer coefficient was the stainless steel 5 mesh controlled at an interface temperature of about 39° F. and interface pressure of about 175 kPa (25 psi). Without being limited by theory, at higher pressures, the results tended to converge due to the decrease in air gap distance where the thermal contact conductance dominates.

The thickness of the mesh specimens were measured both prior and after a test run and a notable decrease in thickness was found at the higher pressures. This indicated that the specimens may have been deformed at the higher pressures. To limit this preloading effect, fresh screen mesh cutouts were placed in the testing specimen for each new test run.

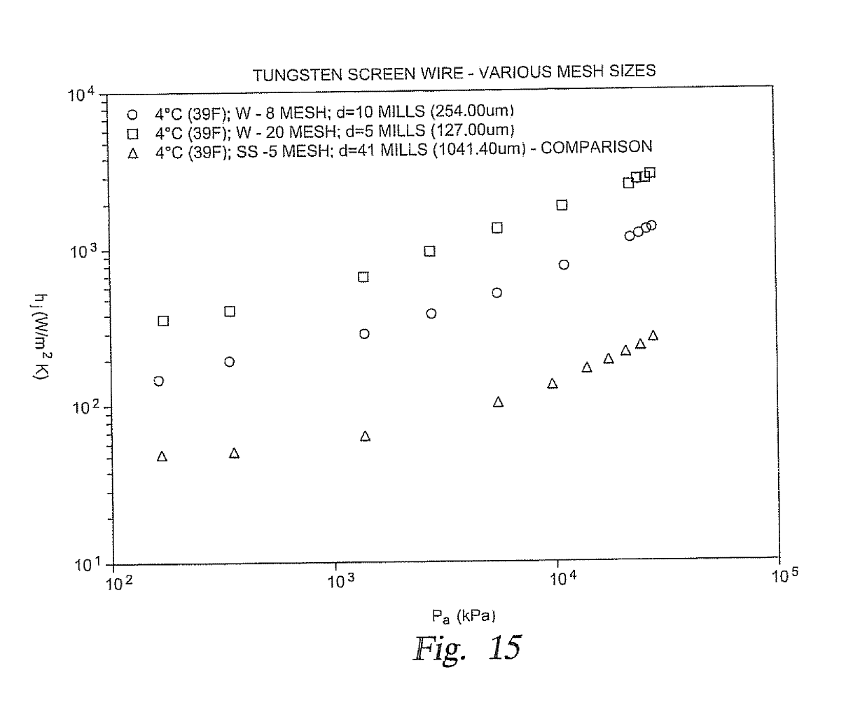

FIG. 15 graphically compares the stainless steel 5 mesh with the titanium screen mesh specimens. The stainless steel 5 screen mesh out-performed the titanium screen mesh. However, since the titanium 9 wire mesh was the smallest mesh number available for testing, it was difficult to definitely conclude that the stainless steel screen mesh was better than the titanium screen mesh. It is to be noted that the cost of titanium screen mesh was considerably higher than the stainless steel screen mesh without any significant improvement in insulating performance.

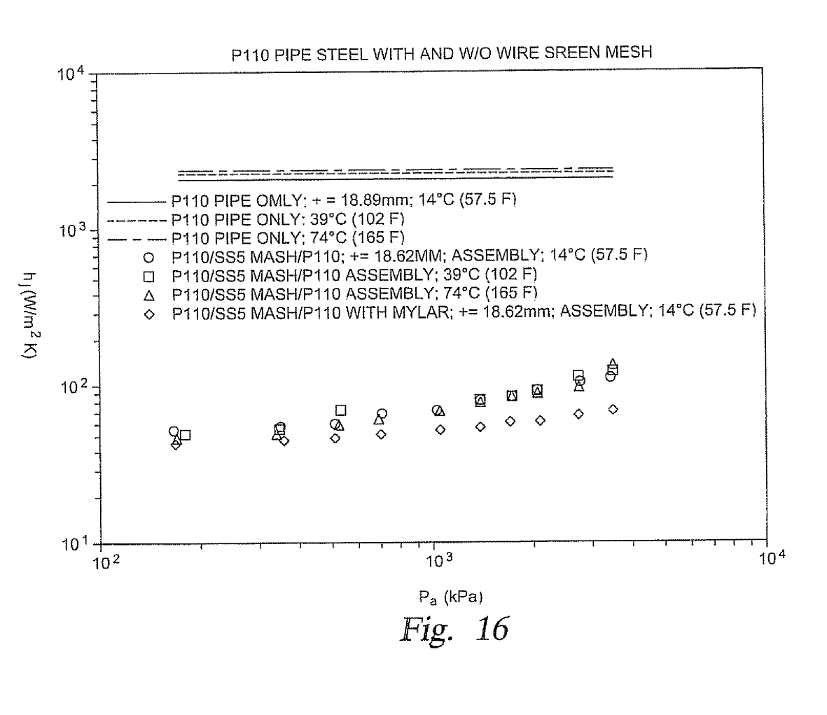

FIG. 16 graphically illustrates the results of the tungsten screen mesh specimens and compares them to the stainless steel 5 mesh. Stainless steel 5 mesh out performed tungsten. Once the best mesh specimen was determined, it was further tested in an assembly similar to a manufactured pipe as shown in EXAMPLE 2.

### Example 2

To quantify the thermal performance of an interstitially insulated tubular, controlled experiments were conducted. The experimental facility was appropriate for simulating deepwater applications.

Stainless steel 5 mesh, the best screen mesh specimen as experimentally determined in EXAMPLE 1, was tested in an assembly similar to a manufactured pipe. The stainless steel 5 mesh was tested between two samples of P110 4140 steel (same material as subsea pipes). The total thickness of this composite pipe wall was 19 mm (0.75 in). Also, a sample of P110 4140 steel, 19 mm (0.75 in) in thickness, without the screen mesh was tested to compare how the screen mesh affected the overall heat transfer coefficient (hⱼ).

The TCC system 900 illustrated in FIG. 14 and described above was used to conduct the test runs. The experimental study encompassed the range of interface pressures and temperatures typically experienced by subsea pipelines during normal operations. Also, in certain test runs, a sheet of MYLAR® film, commercially available from DuPont, was added to the screen mesh tests to determine how the mesh would affect the results.

FIG. 17 graphically illustrates the results of this test with a comparison to existing pipe technology currently in use. Without being limited by theory, the experimental data revealed about a two order of magnitude reduction in thermal contact conductance with stainless steel wire screen placed in-between the tubular pipe steel as compared to a tubular pipe thickness without the screen mesh inserted (i.e., 19 mm (0.748 in)). Without being limited by theory, this represented a very large reduction in the pipe thermal conductivity when the stainless steel 5 mesh wire screen was inserted between the steel pipe metal. Further, about an additional 20% reduction in thermal conductance was realized when a sheet of thin (˜12 μm thick (4.7×10⁻⁴ in)) MYLAR® film was placed at the two interfaces encompassed by the screen mesh contact points and the solid pipe metal.

Still referring to FIG. 17, the best combination was the stainless steel 5 mesh with MYLAR® film in the assembly controlled at a mean interface temperature of about 14.7° C. (57.5° F.). The value for the overall heat transfer coefficient at about 167 kPa is about 42.5 W/m²-K (7.48 Btu/hr ft²° F.), and it increases to a value of about 67.4 W/m²K (11.9 Btu/hr ft²° F.) at 3447 kPa (500 psi).

### Example 3

To quantify the thermal performance of an interstitially insulated coaxial pipe, controlled experiments were conducted. The experimental facility was appropriate for simulating deepwater applications. Steel slugs made of the same material as subsea pipes (“X-60 or X-80” pipe or medium-carbon steel P110 4140) were used to represent the subsea pipe walls.

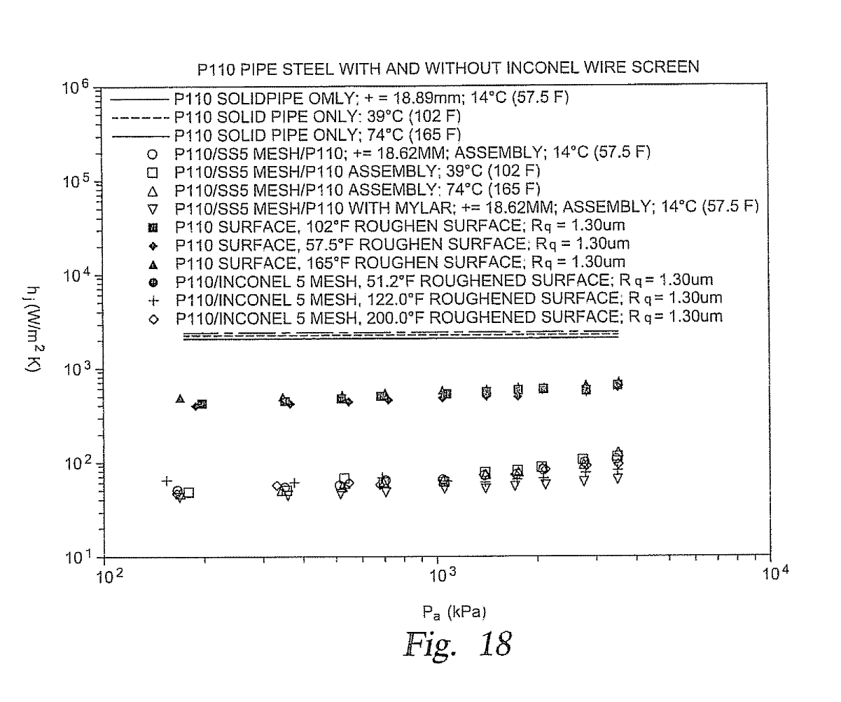

Referring to FIG. 18, each test specimen 940 comprised two flux meters 800, two inserts 402 between the two flux meters 800, and a separator 150 (e.g., screen mesh) positioned between the two inserts 402. The flux meters 800 were fabricated from the steel slugs. Each flux meter 800 had a length of about 3.81 cm (1.5 in.). Five equally spaced holes 801 were drilled to the center of each steel flux meter 800 in order to affix “T” type thermocouples (not shown). The thermocouples measured the axial temperature distributions in the flux meter 800 during testing. The inserts 402 were machined from P110 4140 steel bar stock into cylinders with 1 inch diameters. The machined steel cylinder inserts 402 simulated the inner and outer walls of an interstitial insulating coaxial pipe. The cutouts of separator 150 with a diameter of 2.54 cm (1 inch) were sandwiched between the two cylinder inserts 402, thus mimicking the actual interstitially insulated coaxial pipe under actual temperature and pressure conditions of a subsea environment.

The Thermal Contact Conductance (TCC) system 900 illustrated in FIG. 14 and described above was used to conduct the test runs. Initially, the thermal resistance of the two steel cylinder inserts 402 were measured with just one contacting interface (i.e., with no separator 150 between inserts 402) to obtain a reference value for comparison with the interstitially insulating coaxial pipe. Next, a separator 150 was placed between the two inserts 402 to evaluate the thermal performance of an interstitially insulated coaxial pipe.

The experimental study encompassed the range of interface pressures and temperatures typically experienced by subsea pipelines during normal operations. Table 2 summarizes the experimental parameters used to ascertain the overall thermal resistance resulting from the insertion of the wire screen between the two separated steel inserts with air as the interstitial medium (i.e., air filled the gaps in the screen mesh). In some test runs, an inconel 625 screen mesh was placed between two irregular (e.g., roughened) steel inserts.

TABLE 2

| | | Interface |
|---|---|---|
| | | Temperature |
| Surface Finish | Interface Pressure (kPa) | (C.) |
| Machine finish | 172.4, 344.7, 517.1, 689.5, 1034.2, | 17 |
| (not polished) | 1379, 1723.7, 2068.4, 2758, 3447.4 | |
| Machine finish | 172.4, 344.7, 517.1, 689.5, 1034.2, | 47 |
| (not polished) | 1379, 1723.7, 2068.4, 2758, 3447.4 | |
| Machine finish | 172.4, 344.7, 517.1, 689.5, 1034.2, | 87 |
| (not polished) | 1379, 1723.7, 2068.4, 2758, 3447.4 | |
| Roughened | 172.4, 344.7, 517.1, 689.5, 1034.2, | 17 |
| interface surface | 1379, 1723.7, 2068.4, 2758, 3447.4 | |
| With Inconel | | |
| Roughened | 172.4, 344.7, 517.1, 689.5, 1034.2, | 47 |
| interface surface | 1379, 1723.7, 2068.4, 2758, 3447.4 | |
| With Inconel | | |
| Roughened | 172.4, 344.7, 517.1, 689.5, 1034.2, | 87 |
| interface surface | 1379, 1723.7, 2068.4, 2758, 3447.4 | |
| With Inconel | | |

The experimental results compared the overall heat transfer coefficient (hⱼ) to the interface pressure and temperature.

FIG. 19 graphically illustrates the experimental results for inconel as a function of applied interface pressure and interface temperature. A variety of configurations were tested which included a solid P110 steel pipe, P110 steel pipe composed of two steel inserts with roughened contact surfaces, and then a P110 pipe composed of two steel inserts with an inconel wire screen placed between the two inserts. The latter configuration simulated an embodiment of the interstitially insulated tubular of the present invention. The pipe composed of two steel inserts with roughened contact surfaces revealed a thermal joint conductance of about four times less than the solid steel pipe. Further, the pipe composed of two steel inserts with an inconel wire screen placed between the two inserts revealed a thermal joint conductance of about one 10 times less than the pipe composed of two steel inserts with roughened contact surfaces. Still further, the pipe composed of two steel inserts with an inconel wire screen placed between the two inserts revealed a thermal joint conductance of about forty times less than the solid steel pipe configuration.

What is claimed is:

1. An interstitially insulated pipeline for flowing a hydrocarbon, comprising:
a first interstitially insulated pipe and a second interstitially insulated pipe, wherein each interstitially insulated pipe comprises an inner pipe, an outer pipe mounted coaxially around the inner pipe, an insulating interstice radially positioned between the inner pipe and the outer pipe, and a layer of screen mesh having a mesh size 10 or less disposed in the insulating interstice and at least partially engaging the inner pipe and the outer pipe; and
a joint coupling the first interstitially insulated pipe and the second interstitially insulated pipe end-to-end, wherein the joint includes a connection that couples the outer pipe of the first interstitially insulated pipe to the outer pipe of the second interstitially insulated pipe, and an annular seal member disposed between the inner pipe of the first interstitially insulated pipe and the inner pipe of the second interstitially insulated pipe.

2. The interstitially insulated pipeline of claim 1 wherein each interstitially insulated pipe includes a plurality of layers of screen mesh, each layer of screen mesh having a mesh size 10 or less.

3. The interstitially insulated pipeline of claim 2 wherein each layer of screen mesh has a mesh size of 5 or less.

4. The interstitially insulated pipeline of claim 1 further comprising an annular thermal insulator radially positioned between the connection and the screen mesh of the first interstitially insulated pipe.

5. The interstitially insulated pipeline of claim 4 wherein the radially inner surface of each outer pipe includes an annular recess adapted to accommodate the thermal insulator.

6. The interstitially insulated pipeline of claim 4 wherein the thermal insulator comprises an material selected from the group consisting of a ceramic and a polymer.

7. The interstitially insulated pipeline of claim 6 wherein each outer pipe comprises steel, and wherein the connection that couples the outer pipe of the first interstitially insulated pipe to the outer pipe of the second interstitially insulated pipe is a welded connection.

8. The interstitially insulated pipeline of claim 1 wherein the inner pipe and the screen mesh of the first interstitially insulated pipe extend axially beyond the outer pipe of the first interstitially insulted pipe by a first axial distance, wherein the outer pipe of the second interstitially insulated pipe extends axially from the inner pipe and the screen mesh of the second interstitially insulated pipe by a second axial distance that is about the same as the first axial distance.

9. The interstitially insulated pipeline of claim 1 wherein the outer pipe of the first interstitially insulated pipe extends axially beyond the screen mesh and the inner pipe of the first interstitially insulated pipe, wherein the inner radial surface of the portion of the outer pipe of the first interstitially insulate pipe extending axially beyond the screen mesh and the inner pipe of the first interstitially insulated pipe includes a plurality of steps, and wherein the outer radial surface of the outer pipe of the second interstitially insulated pipe includes a plurality of steps adapted to mate with the plurality of steps on the inner radial surface of the portion of the outer pipe of the first interstitially insulate pipe.

10. The interstitially insulated pipeline of claim 1 wherein the outer pipe of the second interstitially insulated pipe at least partially overlaps with the screen mesh and the inner pipe of the first interstitially insulated pipe.

11. The interstitially insulated pipeline of claim 1 wherein the annular seal member has a T-shaped cross-section including a radially inner base portion and radially outer axial extensions.

12. The interstitially insulated pipeline of claim 11 wherein the inner pipe of each interstitially insulated pipe forms a sliding seal with the radially inner surface of one of the axial extensions of the annular seal member.

13. The interstitially insulated pipeline of claim 12 wherein the radially inner surface of the outer pipe of the second interstitially insulated pipe includes an annular recess within which the radially outer most portion of the axial extensions of the annular seal member are at least partially disposed.

14. The interstitially insulated pipeline of claim 12 wherein the annular seal member comprises a polymer.

15. The interstitially insulated pipeline of claim 1 wherein the annular seal member includes two concave lateral surfaces in cross-section, one concave lateral surface adapted to wedge the screen mesh and the inner pipe of the first interstitially insulated pipe together, and the other concave lateral surface adapted to wedge the screen mesh and the inner pipe of the second interstitially insulated pipe together.

16. The interstitially insulated pipeline of claim 7 wherein each screen mesh is stainless steel.

17. The interstitially insulated pipeline of claim 3 wherein each interstitially insulated pipe includes a plurality of intermediate layers between the inner pipe and the outer pipe, each intermediate layer disposed between two of the plurality of layers of screen mesh.

18. The interstitially insulated pipeline of claim 17 wherein at least one of the plurality of intermediate layers comprises MYLAR®.

19. The interstitially insulated pipeline of claim 18 wherein each layer of MYLAR® comprises aluminized MYLAR®.

20. The interstitially insulated pipeline of claim 5 wherein each insulating interstice has a radial thickness between 0.125 in. and 1.0 in.

21. The interstitially insulated pipeline of claim 20 wherein each inner pipe has a radial thickness between 0.125 in. and 1.500 in.

22. The interstitially insulated pipeline of claim 20 wherein each outer pipe has a radial thickness between 0.125 in. and 1.5 in.

23. The interstitially insulated pipeline of claim 22 wherein each inner pipe is a composite pipe comprising a steel pipe having an acid resistant liner.

24. The interstitially insulated pipeline of claim 23 wherein the acid resistant liner comprises a material selected from the group consisting of stainless steel and inconel.

25. The interstitially insulated pipeline of claim 24 wherein the outer radial surface of each outer pipe comprises a salt water resistant material.

26. A method of fabricating a subsea pipeline comprising:
providing a first and a second interstitially insulated pipe segment, each interstitially insulated pipe segment comprising an inner pipe, an outer pipe coaxially mounted about the inner pipe, an insulating interstice positioned between the inner pipe and the outer pipe, and a plurality of layers of screen mesh disposed in the insulating interstice, wherein each layer of screen mesh has a mesh number of 10 or less;
connecting the first interstitially insulated pipe segment to the second interstitially insulated pipe segment end-to-end;
forming a joint between the first interstitially insulated pipe segment and the second interstitially insulated pipe segment; and
disposing the first interstitially insulated pipe segment at least partially subsea.

27. The method of claim 26 wherein each screen mesh comprises stainless steel.

28. The method of claim 26 wherein the plurality of layers of screen mesh and the inner pipe of the first interstitially insulated pipe segment extend axially beyond the outer pipe of the first interstitially insulated pipe segment, and wherein the outer pipe of the second interstitially insulated pipe segment extends axially beyond the screen mesh and the inner pipe of the second interstitially insulated pipe segment, and wherein forming the joint comprises coaxially inserting the screen mesh and the inner pipe of the first interstitially insulated pipe segment into the outer pipe of the first interstitially insulated pipe segment.

29. The method of claim 28 wherein forming the joint further comprises:
disposing an annular seal member between the inner pipe of the first interstitially insulated pipe segment and the inner pipe of the second interstitially insulated pipe segment; and
connecting the outer pipe of the first interstitially insulated pipe segment to the outer pipe of the second interstitially insulated pipe segment to form a fluid tight connection between the outer pipe of the first interstitially insulated pipe segment to the outer pipe of the second interstitially insulated pipe segment.

30. The method of claim 29 wherein forming the joint further comprises positioning an annular thermal insulator radially between the plurality of layers of screen mesh of the first interstitially insulated pipe segment and both the outer pipes of the first and second interstitially insulated pipe segments.

31. The method of claim 30 wherein each outer pipe comprises steel, and wherein connecting the outer pipe of the first interstitially insulated pipe segment to the outer pipe of the second interstitially insulated pipe segment comprises welding the outer pipe of the first interstitially insulated pipe segment to the outer pipe of the second interstitially insulated pipe segment.

32. The method of claim 29 further comprising forming an annular seal between the inner pipe of the first interstitially insulated pipe segment and the inner pipe of the second interstitially insulated pipe segment with the annular seal member.

33. The method of claim 32 wherein the annular seal member has a T-shaped cross-section including a radially inner base portion and radially outer axial extensions.

34. The method of claim 33 wherein the inner pipe of the first interstitially insulated pipe segment forms a sliding seal with the radially inner surface of one of the axial extensions of the annular seal member and the inner pipe of the second interstitially insulated pipe segment forms a sliding seal with the radially inner surface of the other axial extension of the annular seal member.

35. The method of claim 26 wherein each insulating interstice has a radial thickness of at least 0.125 in.

36. The method of claim 26 wherein each inner pipe is a composite pipe comprising a steel pipe having an acid resistant liner.

37. The method of claim 36 wherein the acid resistant liner comprises a material selected from the group consisting of stainless steel and inconel.

38. A method for transporting a hydrocarbon fluid comprising:
disposing a first tubular at least partially subsea;
flowing the hydrocarbon fluid through the first tubular;
insulating the hydrocarbon fluid flowing through the first tubular with an interstice between the first tubular and a second tubular coaxially disposed about the first tubular; and
maintaining the interstice between the first tubular and a second tubular with a layer of screen mesh disposed between the first tubular and the second tubular.

39. The method of claim 38 wherein the layer of screen mesh has a mesh size of 10 or less.

40. The method of claim 39 wherein the at least one layer of screen mesh comprises a plurality of layers of screen mesh, each layer of screen mesh having a mesh number of 5 or less and comprising stainless steel.

41. The method of claim 40 wherein the first tubular, the interstice, the screen mesh, and the second tubular form a composite tubular wall, and wherein insulating the hydrocarbon fluid further comprises maintaining an overall heat transfer coefficient across of the composite tubular wall of less than 300 W/m²K.

42. The method of claim 41 wherein insulating the hydrocarbon fluid further comprises maintaining an overall heat transfer coefficient across of the composite tubular wall of less than 50 W/m²K.

43. The method of claim 42 wherein insulating the hydrocarbon fluid further comprises the step of maintaining an overall heat transfer coefficient across of the composite tubular wall of less than 10 W/m²K.

44. The method of claim 40 wherein the hydrocarbon fluid comprises produced crude oil having a paraffin cloud point temperature and insulating the hydrocarbon fluid comprises maintaining the temperature of the crude oil above the paraffin cloud point temperature.

45. The method of claim 40 wherein the interstice comprises air.

46. A subsea pipeline comprising:
a rigid inner pipe;
a rigid outer pipe disposed coaxially around the inner pipe so as to form an interstice between the inner pipe and the outer pipe; and
a layer of screen mesh disposed in the interstice between the inner tubular and the outer tubular, wherein the screen mesh has a mesh number of 10 or less.

47. The subsea pipeline of claim 46 wherein the layer of screen mesh is stainless steel.

48. The subsea pipeline of claim 46 further comprising a layer of MYLAR® positioned between the inner pipe and the outer pipe.

49. The subsea pipeline of claim 48 wherein the layer of MYLAR® comprises aluminized MYLAR®.

50. The subsea pipeline of claim 46 wherein the inner pipe, the outer pipe, the interstice, and the layer of screen mesh form a composite pipe wall, wherein the composite pipe wall has a thickness of at least 0.75 inches.

51. The subsea pipeline of claim 46 wherein the inner pipe has an outer surface that is at least partially knurled.

52. The subsea pipeline of claim 46 further comprising a plurality of layers of screen mesh disposed in the interstice between the inner tubular and the outer tubular.

53. The subsea pipeline of claim 52 wherein the outer pipe comprises a salt water resistant protective coating on its outer surface.

54. The subsea pipeline of claim 53 wherein the inner pipe comprises an acid resistant material on its inner surface.
